(19) United States
(12) Patent Application Publication
(10) Pub. No.: US 2013/0336276 A1
(43) Pub. Date: Dec. 19, 2013

(54) WIRELESS COMMUNICATION SYSTEM, WIRELESS TRANSMISSION METHOD, TRANSMITTING DEVICE, AND PROCESSOR

(71) Applicants: Hiroki Takahashi, Osaka-shi (JP); Yasuhiro Hamaguchi, Osaka-shi (JP); Kazunari Yokomakura, Osaka-shi (JP); Osamu Nakamura, Osaka-shi (JP); Jungo Goto, Osaka-shi (JP)

(72) Inventors: Hiroki Takahashi, Osaka-shi (JP); Yasuhiro Hamaguchi, Osaka-shi (JP); Kazunari Yokomakura, Osaka-shi (JP); Osamu Nakamura, Osaka-shi (JP); Jungo Goto, Osaka-shi (JP)

(73) Assignee: SHARP KABUSHIKI KAISHA, Osaka-shi, Osaka (JP)

(21) Appl. No.: 14/000,561

(22) PCT Filed: Feb. 21, 2012
(86) PCT No.: PCT/JP2012/054084

§ 371 Date: Sep. 3, 2013

(30) Foreign Application Priority Data
Feb. 21, 2011 (JP) 2011-034560

(51) Int. Cl. H04W 72/04

(52) U.S. Cl. CPC H04W 72/0453
USPC 370/329

(57) ABSTRACT

A transmitting device is a transmitting device configured to transmit a signal, and is provisioned with a determination unit configured to determine whether or not to perform a frequency clipping to remove a portion of a spectrum of the signal to transmit on the basis of a control information representing a frequency band used by the transmitting device to transmit data.

### TECHNICAL FIELD

The present invention relates to a wireless communication system, wireless transmission method, transmitting device, and processor.

The present application claims priority to Japanese Patent Application No. 2011-034560 filed on Feb. 21, 2011, the entire contents of which are incorporated by reference herein.

### BACKGROUND ART

Various wireless communication systems, primarily cellular phone networks and wireless LANs (Local Area Network), have been recently put into practical application, and technical investigations are currently performed to enable each system with high speed transmission. However, as many different types of wireless communication systems and the use of wideband technologies in these systems continue to increase, a problem in which the usable frequency source is becoming scarce is occurring. In order to achieve improvements in throughput under these circumstances, technologies are being investigated to improve the usage efficiency of each frequency.

The SC-FDMA (Single Carrier Frequency Division Multiple Access) method, which allocates a single carrier to contiguous frequencies, is used in the uplinks (from a mobile station to a base station) in LTE (Long Term Evolution) systems, which are the 3.9 generation of wireless communication systems. Further, SC-FDMA is also referred to as DFT-S-OFDM (Discrete Fourier Transform Spread Orthogonal Frequency Division Multiplexing), DFT-Precoded OFDM, and OFDM with DFT Precoding, and so forth.

Regarding this SC-FDMA method, it has been determined regarding the LTE-A (LTE-Advanced) transmission format which is the next-generation standard for LTE, to adopt Clustered DFT-S-OFDM (also referred to as DSC (Dynamic Spectrum Control), SC-ASA (Single Carrier Adaptive Spectrum Allocation), DFT-S-OFDM with SDC (Spectrum Division Control), and similar), which divides the single carrier spectrum into clusters of frequency domains known as portional spectra and non-contiguously allocate each cluster into highly advantageous bands. According to the Clustered DFT-S-OFDM, the communications device must notify the allocated position of each cluster. NPL 1 discloses an notification method of the band allocation information having a maximum cluster number of two (refer to FIG. 4 regarding NPL 1).

Also, PTL 1 discloses a wireless communication system applying a frequency clipping technology (also referred to as Clipped DFT-S-OFDM, frequency domain puncturing, and similar). According to the frequency clipping technology, a portion of the band regarding the frequency domain signal at the transmitting device is clipped (deleted), and a non-linear repeating equalization processing is used in the receiving device.

### CITATION LIST

### Patent Literature

PTL 1: Japanese Unexamined Patent Application Publication No. 2008-219144

### Non Patent Literature

NPL 1: 3GPP TSG RAN WG1 Meeting #61 bis R1-104019

### SUMMARY OF INVENTION

### Technical Problem

However, according to the technology disclosed in PTL 1, the usage frequency band for each data sequence is notified to the transmitting device, which increases the amount of control information, and creates a problem in which the transmission efficiency of the communication system is decreased.

The present invention is the result of considering the problems described beforehand, and provides a wireless communication system, wireless communication method, transmitting device, and processor that can perform the frequency clipping while preventing the loss of transmission efficiency.

### Solution to Problem

(1) The present invention is the result of considering how to resolve the previously described problems, in which a first form of the present invention is a wireless communication system provisioned with a first communications device configured to transmit a signal, and a second communications device configured to receive the signal, wherein the second communications device is provisioned with a transmitting unit to transmit a control information, which represents a frequency band used by the first communications device to transmit data, to the first communications device, and wherein the first communications device is provisioned with a determination unit to determine whether or not to perform a frequency clipping to remove a portion of a spectrum of the signal to transmit on the basis of the control information.

(2) Further, regarding the first form of the present invention, the control information may be information representing that the spectrum of the signal transmitted by the first communications device is allocated non-contiguously in the frequency.

(3) Further, regarding the first form of the present invention, the first communications device may determine whether or not to perform the frequency clipping on the basis of whether or not the frequency band represented by the control information satisfies predetermined conditions.

(4) Further, regarding the first form of the present invention, the first communications device may determine to perform the frequency clipping when a clipping ratio that can be calculated from the frequency band represented by the control information is smaller than a predetermined threshold, and determines not to perform the frequency clipping when the clipping ratio is larger than the predetermined threshold.

(5) Further, regarding the first form of the present invention, the clipping ratio may be a ratio calculated when the frequency band represented by the control information is divided into a plurality of clusters and allocated into a non-contiguous allocation, and the entire band between the clusters is lost due to clipping.

(6) Further, regarding the first form of the present invention, the clipping ratio may be a ratio calculated when the frequency band represented by the control information is divided into a plurality of clusters and allocated into a non-contiguous allocation and the narrowest band of the inter-cluster portion of the band between clusters is lost due to clipping.

(7) Further, regarding the first form of the present invention, the predetermined threshold may be a constant value set between both the first communications device and the second communications device.

(8) Further, regarding the first form of the present invention, the predetermined threshold may be a value set on the basis of information known between both the first communications device and the second communications device.

(9) Further, regarding the first form of the present invention, the known information may be an MCS information used when the first communication device transmits.

(10) Further, regarding the first form of the present invention, the known information may be an MIMO rank information used when the first communication device transmits.

(11) Further, regarding a second form of the present invention, a wireless communication method for a wireless communication system is provisioned with a first communications device to transmit a signal, and a second communications device to receive the signal, wherein the second communications device transmits a control information, which represents a frequency band used by the first communications device to transmit data, to the first communications device, and wherein the first communications device determines whether or not to perform the frequency clipping to remove a portion of a spectrum of the signal to transmit on the basis of the control information.

(12) Further, regarding a third form of the present invention, a transmitting device is configured to transmit a signal, and is provisioned with a determination unit configured to determine whether or not to perform the frequency clipping to remove a portion of a spectrum of the signal to transmit on the basis of a control information representing a frequency band used by the transmitting device to transmit data.

(13) Further, regarding a fourth form of the present invention, a processor is configured to determine whether or not to perform a the frequency clipping to remove a portion of a spectrum of a signal transmitted by the transmitting device on the basis of a control information representing a frequency band used by the transmitting device to transmit data.

### Advantageous Effects of Invention

According to the present invention, the frequency clipping can be performed while preventing the loss of transmission efficiency.

### BRIEF DESCRIPTION OF DRAWINGS

FIG. 1 is a description diagram describing an example of an allocation index used in allocation information related to a first Embodiment of the present invention.

FIG. 2 is a schematic diagram illustrating an example of a spectrum regarding a non-contiguous allocation related to the first Embodiment of the present invention.

FIG. 3 is a schematic diagram illustrating an example of a spectrum allocation by the frequency clipping related to the first Embodiment of the present invention.

FIG. 4 is a schematic diagram illustrating an example of a wireless communication system related to the first Embodiment of the present invention.

FIG. 5 is a schematic block diagram illustrating an example configuration of a transmitting device related to the first Embodiment of the present invention.

FIG. 6 is a schematic block diagram illustrating an example configuration of a clipping/non-contiguous allocation switching unit related to the first Embodiment of the present invention.

FIG. 7 is a flowchart illustrating an example of an operation of a clipping determination unit related to the first Embodiment of the present invention.

FIG. 8 is a schematic block diagram illustrating an example configuration of a receiving device related to the first Embodiment of the present invention.

FIG. 9 is a schematic block diagram illustrating an example configuration of a clipping/non-contiguous allocation determination unit related to the first Embodiment of the present invention.

FIG. 10 is a flowchart illustrating an example of an operation of the clipping determination unit related to the first Embodiment of the present invention.

FIG. 11 is a schematic diagram illustrating an example of a wireless communication system related to a modification of a second modification of the present invention.

FIG. 12 is a schematic block diagram illustrating an example configuration of a transmitting device related to a second modification of the present invention.

FIG. 13 is a schematic diagram illustrating an example of a precoding matrix related to the second modification of the present invention.

FIG. 14 is a schematic block diagram illustrating an example configuration of the receiving device related to the second modification of the present invention.

FIG. 15 is a schematic diagram illustrating an example of a threshold table related to the second modification of the present invention.

FIG. 16 is a schematic block diagram illustrating an example configuration of the transmitting device related to a second Embodiment of the present invention.

FIG. 17 is a schematic block diagram illustrating an example configuration of the clipping/non-contiguous allocation switching unit related to the second Embodiment of the present invention.

FIG. 18 is a schematic block diagram illustrating an example configuration of the receiving device related to the second Embodiment of the present invention.

FIG. 19 is a schematic block diagram illustrating an example configuration of the clipping/non-contiguous allocation determination unit related to the second Embodiment of the present invention.

FIG. 20 is a schematic diagram illustrating an example of the threshold table related to a third modification of the present invention.

FIG. 21 is a schematic block diagram illustrating an example configuration of the transmitting device related to the third modification of the present invention.

FIG. 22 is a schematic block diagram illustrating an example configuration of the clipping/non-contiguous allocation switching unit related to the third modification of the present invention.

FIG. 22 is a schematic block diagram illustrating an example configuration of the receiving device related to the third modification of the present invention.

FIG. 24 is a schematic block diagram illustrating an example configuration of the clipping/non-contiguous allocation determination unit related to the third modification of the present invention.

FIG. 25 is a schematic diagram illustrating an example of a spectrum allocation related to a third Embodiment of the present invention.

FIG. 26 is a schematic block diagram illustrating an example configuration of the clipping/non-contiguous allocation switching unit related to the third Embodiment of the present invention.

FIG. 27 is a schematic block diagram illustrating an example configuration of the clipping/non-contiguous allocation determination unit related to the third Embodiment of the present invention.

### DESCRIPTION OF EMBODIMENTS

Hereafter, first through third Embodiments and first through third modifications of the present invention will be described in detail with reference to the drawings. Further, the following first through third Embodiments focus on uplink communication, but a similar technique can be used for downlinks. That is to say, the allocation information used when determining whether or not to perform a frequency clipping or the control information called MCS can be generated by either the transmitting device or the receiving device, and may be notified from the transmitting device to the receiving device.

### First Embodiment

The wireless communication system related to the first Embodiment performs a switching of the frequency clipping and the non-contiguous allocation based on a mapping information (allocation information) and a previously determined threshold value. That is to say, according to the first Embodiment, when allocation information on the non-contiguous allocation representing the allocation positions of two clusters is received, a spectrum allocation by non-contiguous allocation and a spectrum allocation using the frequency clipping is switched on the basis of predetermined conditions. Clusters refer to portions of the spectrum contiguously allocated when non-contiguously allocating a single carrier.

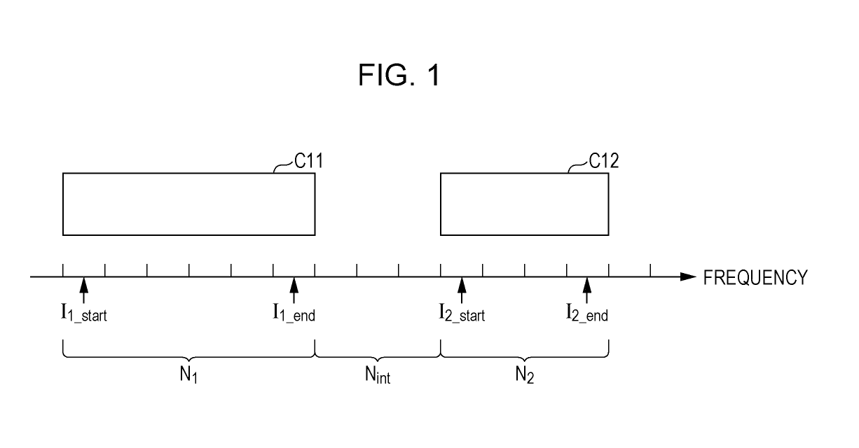

Four entries of allocation index information (allocation starting index and allocation ending index) that can be derived when allocation information on the non-contiguous allocation is received will be described using FIG. 1. FIG. 1 is a description diagram describing an example of the allocation index used in the allocation information related to the first Embodiment of the present invention. According to the first Embodiment, the allocation index is a value representing the allocation unit number (resource) in order from the low frequencies within the band that can allocate the spectrum.

As illustrated in FIG. 1, when allocating a first cluster C11 and a second cluster C12 on a frequency axis, the allocation starting index (I₁_{_{—}}ₛₜₐᵣₜ) and the allocation ending index (I₁_{_{—}}_{end}) for the first cluster C11, and the allocation starting index (I₂_{_{—}}ₛₜₐᵣₜ) and the allocation ending index (I₂_{_{—}}_{end}) for the second cluster are used as the allocation information.

The wireless communication system device can specify the allocation position by understanding these allocation indexes. That is to say, the allocation index information is information representing allocations when multiple, contiguous frequency bands are allocated non-contiguously. The allocation information on the non-contiguous allocation (allocation index information) includes information specifying these four allocation indexes.

A resource number N₁ allocating the first cluster (=I₁_{_{—}}_{end}−I₁_{_{—}}ₛₜₐᵣₜ+1), a resource number N₂ allocating the second cluster (=I₂_{_{—}}_{end}−I₂_{_{—}}ₛₜₐᵣₜ+1), and an inter-cluster resource number Nᵢₙₜ (=I₂_{_{—}}ₛₜₐᵣₜ−I₁_{_{—}}_{end}−1) are calculated from this allocation index information. Further, the total clusters, that is to say, a resource number N_{alloc} (=N₁+N₂) allocating the single carrier spectrum is calculated.

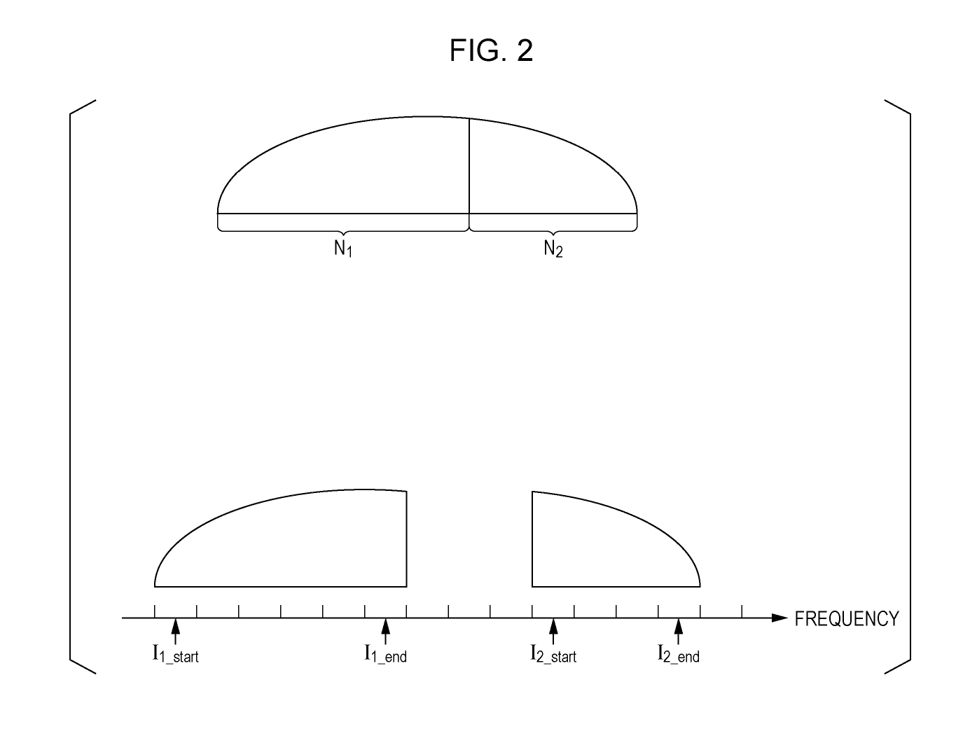

FIG. 2 illustrates a spectrum allocation regarding a non-contiguous allocation when the four entries of the allocation index information in FIG. 1 are received. FIG. 2 is a schematic diagram illustrating an example of a spectrum allocation regarding a non-contiguous allocation related to the first Embodiment. In the case of FIG. 2, the resource number N₁ for the first cluster and the resource number N₂ for the second cluster are added to derive the N_{alloc}. The bandwidth of the transmission signal at the length of this N_{alloc} is designated as N_{D}_{_{—}}_{DFT} of the bandwidth (also referred to as the DFT size or DFT points) when converting spectrum in the frequency domain by DFT (Discrete Fourier Transform: discrete Fourier transform). The transmitting device divides the spectrum generated by DFT of this DFT size N_{D}_{_{—}}_{DFT} into a portion allocated as the first cluster and a portion allocated as the second cluster, and non-contiguously allocates the spectrum by allocating each cluster in arbitrary bands.

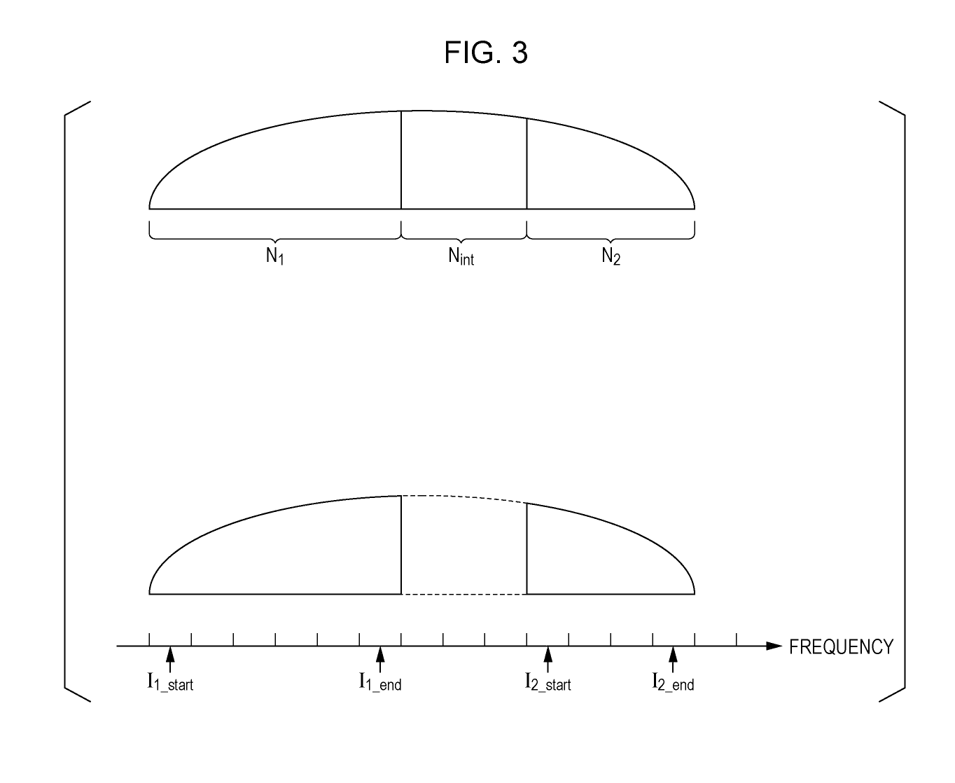

Conversely, according to the first Embodiment, the transmitting device performs a spectrum allocation under predetermined conditions by the frequency clipping using the same allocation information as in the case of the non-contiguous allocation described beforehand. FIG. 3 illustrates an example of a spectrum allocation by the frequency clipping when the four entries of the allocation index information in FIG. 1 are received. FIG. 3 is a schematic diagram representing an example of the spectrum allocation by the frequency clipping related to the first Embodiment.

When performing the frequency clipping, the resource number from adding the inter-cluster resource number Nᵢₙₜ to the cluster resource number N_{alloc} (=N₁+N₂) is designated as DFT size N_{C}_{_{—}}_{DFT} (=N_{alloc}+Nᵢₙₜ). The transmitting device clips the portion of the spectrum corresponding to the Nᵢₙₜ number of resources (inter-cluster resources) from the spectrum generated by DFT of this DFT size N_{C}_{_{—}}_{DFT}, and allocates the remaining spectrum.

Further, regarding FIG. 3, the transmitting device clips the spectrum at the positions corresponding to the inter-cluster portions regarding the non-contiguous allocation with the generated spectrum. However, the first Embodiment of the present invention is not limited thusly, and the transmitting device may clip the spectrum at arbitrary positions so that the total bandwidth after clipping is the same as N_{alloc}. For example, the transmitting device clips a portion of the spectrum for the Nᵢₙₜ number of resources at high frequencies from the spectrum in which the size (bandwidth) equals N_{alloc} plus Nᵢₙₜ. The transmitting device can divide the clipped spectrum at a size of N_{alloc} into clusters, and can allocate the divided spectrum at positions specified by the allocation information. However, the same definition of the clipping positions must be set on both the transmitting device and the receiving device so that the clipping positions can be identified at the receiving device. The transmitting device and the receiving device can notify this definition to the device being communicated with, or multiple definitions can be previously recorded, and information identifying the definition can be notified. Also, this notification can be performed during the connection between the transmitting device and the receiving device, or may be performed at previously determined intervals.

As previously described, the resource number for the spectrum allocated when using the same allocation information is designated as N_{alloc} in both cases of performing the frequency clipping (FIG. 3) and not performing the frequency clipping (FIG. 2). As a result, according to the wireless communication system, transmission can be performed using the same allocation information. However, the wireless communication system can transmit and receive signals including a larger Nᵢₙₜ amount of data when performing the frequency clipping as compared to the non-contiguous allocation (case of not performing the frequency clipping).

When performing the frequency clipping, the spectrum removed by the transmitting device is equivalently lost due to a significantly disadvantageous propagation path of this spectrum at the transmission process, which increases the inter-symbol interference by frequency selective phasing. According to the Clipped DFT-S-OFDM wireless communication system disclosed in NPL 1, this inter-symbol interference is suppressed and the lost spectrum is restored by applying a non-linear repeating equalization processing in the receiving device. However, when the ratio of the spectrum removed by the frequency clipping regarding the generated spectrum (also referred to as the clipping ratio) is significant, the amount of interference generated is large enough such that the non-linear repeating equalization processing cannot operate correctly, and the spectrum cannot be restored.

Thus, according to the Clipped DFT-S-OFDM wireless communication system, there are cases when the transmission properties become considerably degraded as compared to the case in which allocation is performed by the non-contiguous allocation in which the clipping processing is not performed.

According to the wireless communication system related to the first Embodiment, the frequency clipping is performed only when the clipping ratio is at or below a threshold when applying a clipping technology using the allocation information for the non-contiguous allocation; for other cases, the frequency clipping is not performed and the spectrum is allocated by the non-contiguous allocation. As a result, the transmission efficiency can be improved in comparison with the Clipped DFT-S-OFDM wireless communication system according to the related art.

A clipping ratio R_{clip} is represented by the following Expression (1) using the N_{alloc} and the Nᵢₙₜ when the allocation information in FIG. 3 is received.

$${R}_{clip} = \frac{{N}_{int}}{{N}_{alloc} + {N}_{int}} \qquad ( 1 )$$

Also, a threshold Rₗᵢₘᵢₜ used in the determination is expressed by the following Expression (2).

$${R}_{limit} = \frac{E ( {FER}_{C} ( {R}_{limit} ) ) - E ( {FER}_{D} )}{1 - E ( {FER}_{D} )} \qquad ( 2 )$$

Here, E(x) represents the initial value x. Also, the FER_{D} represents the FER (Frame Error Rate; frame error rate) for the non-contiguous allocation, and the FER_{C} represents the FER for the frequency clipping. Note that the threshold Rₗᵢₘᵢₜ does not have to be the value in Expression (2), and may be a constant determined beforehand. Also, the threshold Rₗᵢₘᵢₜ can be a value selected from multiple previously determined integers on the basis of the quality of the received signal or the like.

Further, according to the wireless communication system, maximum transmission throughput can be achieved by using the threshold Rₗᵢₘᵢₜ expressed by the Expression (2). The reason for this is described hereafter.

The initial value for the transmission throughput is defined as the “transmission rate” times the “one minus the initial value of the frame error rate”. Using a transmission rate R_{T}_{_{—}}_{D} when using the non-contiguous allocation, the transmission rate when using the frequency clipping at the clipping ratio R_{clip} is expressed as R_{T}_{_{—}}_{D}/(1−R_{clip}). Thus, the transmission throughput can be maximized by designating the threshold Rₗᵢₘᵢₜ as the clipping ratio R_{clip} when the transmission throughput for the non-contiguous allocation and the transmission throughput for the frequency clipping is equivalent. That is to say, the Expression (2) is a modification of R_{T}_{_{—}}_{D}/(1−Rₗᵢₘᵢₜ)×“1−the FER for the frequency clipping (initial value of FER_{C} (Rₗᵢₘᵢₜ)””=R_{T}_{_{—}}_{D}×“1−initial value of FER (FER_{D}) for the non-contiguous allocation”, and the transmission throughput can be maximized by using the threshold Rₗᵢₘᵢₜ expressed by the Expression (2).

According to the wireless communication system related to the first Embodiment, the clipping ratio R_{clip} when the allocation information is received is obtained according to the Expression (1), and the threshold Rₗᵢₘᵢₜ is obtained according to the Expression (2). The transmitting device and the receiving device determines that the frequency clipping processing should not be performed and that the non-contiguous allocation processing is performed when the Rₗᵢₘᵢₜ is less than the R_{clip}, and determines that the frequency clipping processing is performed when the Rₗᵢₘᵢₜ is greater than or equal to R_{clip}.

[Configuration of Wireless Communication System]

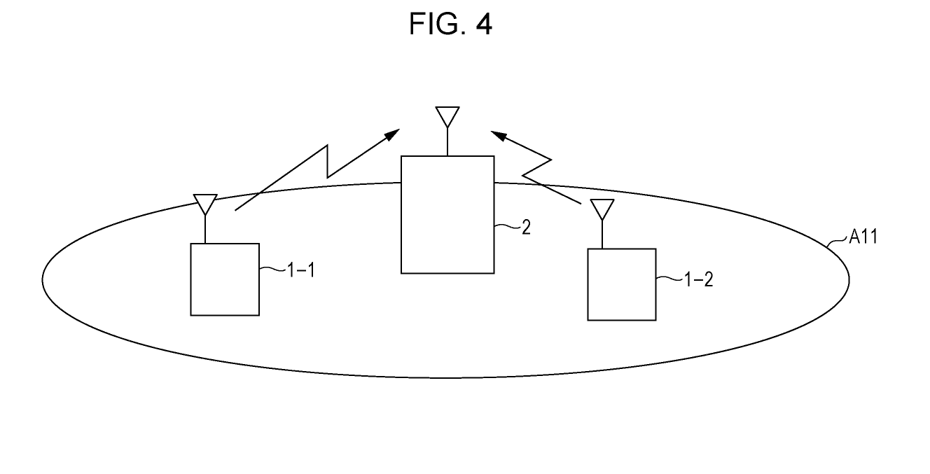

FIG. 4 is a schematic diagram illustrating an example of the wireless communication system related to the first Embodiment. The wireless communication system is provisioned with a first transmitting device 1-1, a second transmitting device 1-2 (each forming a transmitting device 1), and a receiving device 2. The first transmitting device 1-1 and the second transmitting device 1-2 are mobile station devices, for example. The receiving device 2 is a base station, for example. The first transmitting device 1-1, the second transmitting device 1-2, and the receiving device 2 in FIG. 4 are present in an area called a cell A11. Further, according to the example in FIG. 4, the number of the transmitting devices 1 is two, but the number of the transmitting devices 1 can be one, or can be three or more.

The first transmitting device 1-1, the second transmitting device 1-2, and the receiving device 2 are each provisioned with one antenna. The receiving device 2 receives signals transmitted from the first transmitting device 1-1 and the second transmitting device 1-2. According to the wireless communication system, the SC-FDMA (Single Carrier Frequency Division Multiple Access) method using contiguous allocations, the Clustered DFT-S-OFDM method using a non-contiguous allocation where the maximum cluster size is two, or the Clipped DFT-S-OFDM method performing the frequency clipping is used as the transmission method used for transmission.

[Configuration of Transmitting Device]

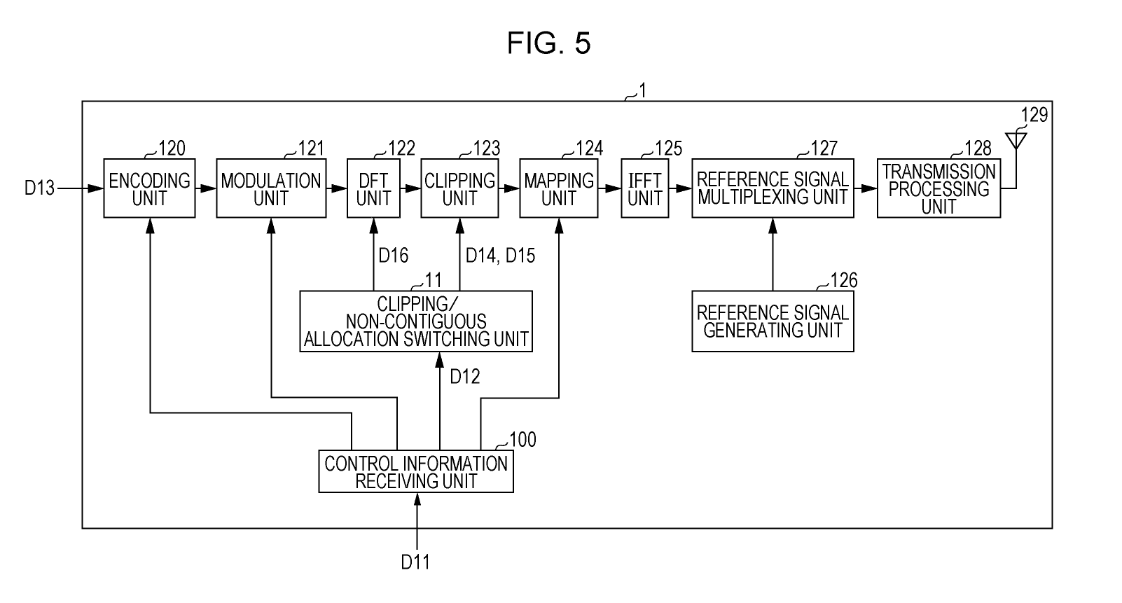

FIG. 5 is a schematic block diagram illustrating an example configuration of the transmitting device 1 (the first transmitting device 1-1 and the second transmitting device 1-2) related to the first Embodiment. However, the transmitting device 1 can be provisioned with a configuration other than the configuration illustrated in FIG. 5, and so can be provisioned with multiple transmission antennae, for example.

The transmitting device 1 is provisioned with a control information receiving unit 100, a clipping/non-contiguous allocation switching unit 11, an encoding unit 120, a modulation unit 121, a DFT unit 122, a clipping unit 123, a mapping unit 124, an IFFT unit 125, a reference signal generating unit 126, a reference signal multiplexing unit 127, a transmission processing unit 128, and a transmission antenna 129.

Before the transmission of data is performed, various parameters (encoding ratio, modulation method, allocation information, and so on) used in the transmission are notified from the receiving device 2 to the transmitting device 1 as control information. Further, the allocation represented by the allocation information can be different for each of the transmitting devices 1-1 and 1-2, or this can be the same.

The control information receiving unit 100 receives a control information D11 notified by the receiving device 2. The control information receiving unit 100 outputs the encoding ratio information within the received control information D11 to the encoding unit 120, outputs the modulation method information to the modulation unit 121, and outputs an allocation information D12 to the clipping/non-contiguous allocation switching unit 11 and the mapping unit 124.

However, each device in the wireless communication system can handle the encoding ratio information and the modulation method information as one type of information (MCS; Modulation and Coding Scheme). Also, each device uses a format for the allocation information corresponding to the contiguous allocation and the non-contiguous allocation. Each device uses information that can identify allocation positions for a single carrier as the allocation information regarding the contiguous allocation allocating contiguous frequency bands. For example, each device handles the first cluster in FIG. 1 as one contiguous allocation, and uses the two entries of the allocation index information, the allocation starting index I₁_{_{—}}ₛₜₐᵣₜ and the allocation ending I₁_{_{—}}_{end}. Also, each device uses information that can identify the allocation positions for multiple clusters as the allocation information regarding the non-contiguous allocation, and for example, uses the allocation information for the non-contiguous allocation described beforehand when the number of clusters is two. Further, the allocation information related to the first Embodiment of the present invention is not limited to the illustrated example. The allocation information, for example, can correspond with a bit series combination of four entries of the allocation index information as illustrated in NPL 1 in which the allocation information corresponds with all RBGs within the system band one bit at a time, and can also use a bit map method performing an allocation of only RBGs in which these bits equal one.

The encoding unit 120 conducts an error correction encoding processing on the bit sequence for a transmission data D13 on the basis of the encoding ratio information input by the control information receiving unit 100. The encoding unit 120 outputs the bit (encoded bits) sequence after the error correction encoding processing to the modulation unit 121.

The modulation unit 121 generates a modulated signal by modulating the bit sequence input by the encoding unit 120 on the basis of the modulation method information input by the control information receiving unit 100. The modulation unit 121 modulates, for example, by QPSK (Quaternary Phase Shift Keying), 16QAM (16-ary Quadrature Amplitude Modulation), or similar. The modulation unit 121 outputs the generated modulated signal to the DFT unit 122.

The clipping/non-contiguous allocation switching unit 11 generates the DFT size information representing the DFT size on the basis of the allocation information input by the control information receiving unit 100, and outputs the generated DFT size information to the DFT unit 122. The clipping/non-contiguous allocation switching unit 11 generates a clipping control information on the basis of the allocation information input by the control information receiving unit 100, and outputs the generated clipping control information to the clipping unit 123. Here, using the DFT size information and the clipping control information to control the DFT unit 122 and the clipping unit 123, the clipping/non-contiguous allocation switching unit 11 performs the switching between transmitting a signal after performing the frequency clipping and transmitting a signal by non-contiguous allocation, without performing the frequency clipping.

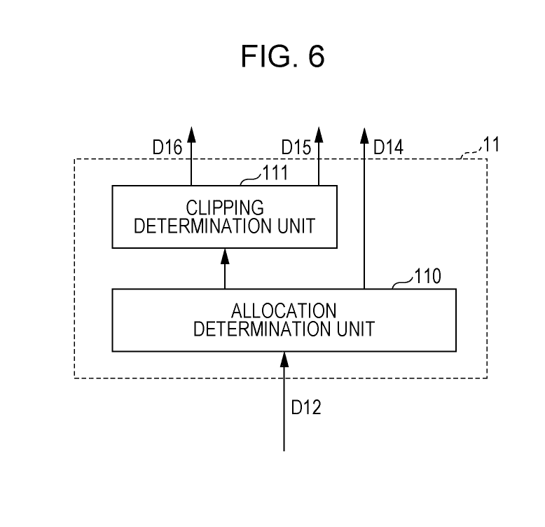

FIG. 6 is a schematic block diagram illustrating an example configuration of the clipping/non-contiguous allocation switching unit 11 related to the first Embodiment. The clipping/non-contiguous allocation switching unit 11 is provisioned with an allocation determination unit 110 and a clipping determination unit 111.

The allocation determination unit 110 calculates the total resource number N_{alloc} for all clusters and the inter-cluster resource number Nᵢₙₜ on the basis of the allocation information D12 input by the control information receiving unit 100.

Here, the allocation information related to the first Embodiment includes four entries of the allocation index information (I₁_{_{—}}ₛₜₐᵣₜ, I₁_{_{—}}_{end}, I₂_{_{—}}ₛₜₐᵣₜ, and I₂_{_{—}}_{end}) when the allocation information is for the non-contiguous allocation, and two entries of the allocation index information (I₁_{_{—}}ₛₜₐᵣₜ, I₁_{_{—}}_{end}) for the contiguous allocation. The allocation determination unit 110 determines whether the allocation information input by the control information receiving unit 100 is the allocation information for the contiguous allocation or the allocation information for the non-contiguous allocation by the presence or lack of the values I₂_{_{—}}ₛₜₐᵣₜ and I₂_{_{—}}_{end}.

The allocation determination unit 110 calculates the total resource number N_{alloc} for all clusters as N₁+N₂, and the inter-cluster resource number Nᵢₙₜ as Iₛ_{_{—}}ₛₜₐᵣₜ−I₁_{_{—}}_{end}−1, using the four entries of the allocation index information included in the allocation information when this allocation information is determined to be for the non-contiguous allocation (Refer to FIG. 2). The allocation determination unit 110 calculates the N_{alloc} as I₁_{_{—}}_{end}−I₁_{_{—}}ₛₜₐᵣₜ+1, and sets the Nᵢₙₜ to zero, using the two entries of the allocation index information included in the allocation information when this allocation information is determined to be for the contiguous allocation.

The allocation determination unit 110 outputs an information D14 representing the calculated N_{alloc} and Nᵢₙₜ to the clipping determination unit 111.

Also, the allocation determination unit 110 calculates the index Nₛₜₐᵣₜ as N₁+1. This index Nₛₜₐᵣₜ is information used when performing the frequency clipping, and is information for representing from what spectral number to clip. However, the allocation determination unit 110 does not need to calculate the Nₛₜₐᵣₜ when the clipping position is identifiable by only the clipping ratio. The allocation determination unit 110 outputs an information D15 representing the calculated Nₛₜₐᵣₜ to the clipping unit 123.

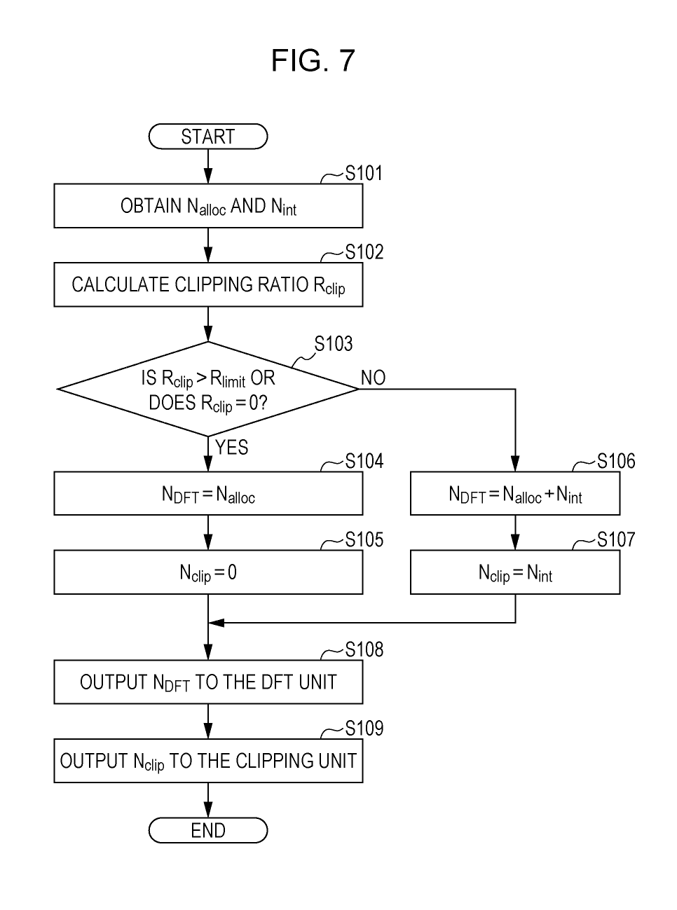

The clipping determination unit 111 performs a determination on whether to perform the frequency clipping by performing a processing as in the flowchart illustrated in FIG. 7, on the basis of the N_{alloc} and Nᵢₙₜ as represented by the information input from the allocation determination unit 110.

FIG. 7 is a flowchart illustrating an example operation of the clipping determination unit 111 related to the first Embodiment.

(Step S101) The clipping determination unit 111 obtains the information representing the N_{alloc} and Nᵢₙₜ from the allocation determination unit 110. Afterwards, processing proceeds to step S102.

(Step S102) The clipping determination unit 111 calculates the clipping ratio R_{clip} for performing the frequency clipping by substituting the N_{alloc} and Nᵢₙₜ represented by the information obtained at step S101 into the Expression (1). Afterwards, processing proceeds to step S103.

(Step S103) The clipping determination unit 111 determines whether or not the clipping ratio R_{clip} calculated at step S102 is larger than the previously stored threshold Rₗᵢₘᵢₜ (R_{clip} is greater than Rₗᵢₘᵢₜ), and whether or not the clipping ratio R_{clip} calculated at step S102 is zero (contiguous allocation). When the clipping ratio R_{clip} is larger than the threshold Rₗᵢₘᵢₜ, or when the clipping ratio R_{clip} is zero (Yes), the clipping determination unit 111 determines not to perform the frequency clipping, and processing proceeds to step S104. Conversely, when the clipping ratio R_{clip} is at or below the threshold Rₗᵢₘᵢₜ and the clipping ratio R_{clip} is not zero (No), the clipping determination unit 111 determines to perform the frequency clipping, and processing proceeds to step S106.

(Step S104) The clipping determination unit 111 substitutes the value of N_{alloc} into the DFT size N_{DFT}. Afterwards, processing proceeds to step S105.

(Step S105) The clipping determination unit 111 substitutes a zero into the clipping number N_{clip}. Afterwards, processing proceeds to step S108.

(Step S106) The clipping determination unit 111 substitutes the value of N_{alloc}+Nᵢₙₜ into the DFT size N_{DFT}. Afterwards, processing proceeds to step S107.

(Step S107) The clipping determination unit 111 substitutes the value of Nᵢₙₜ into the clipping number N_{clip}. Afterwards, processing proceeds to step S108.

(Step S108) The clipping determination unit 111 outputs DFT size information D16 indicating the DFT size N_{DFT} to which values where substituted at either step S104 or step S106, to the DFT unit 122. Afterwards, processing proceeds to step S109.

(Step S109) The clipping determination unit 111 outputs the clipping control information representing the clipping number N_{clip} to which values were substituted at either step S105 or step S107 to the DFT unit 122. Afterwards, the processing terminates.

Further, the order of the step S104 and the step S105, the order of the step S106 and the step S107, and the order of the step S108 and the step S109 can be reversed.

By performing the processing as previously described, the clipping/non-contiguous allocation switching unit 11 can suitably switch between transmission by non-contiguous allocation and transmission by clipping.

Returning to FIG. 5, the DFT unit 122 converts the modulated signal input by the modulation unit 121 into a frequency domain signal by performing DFT. Here, the DFT unit 122 performs DFT with the DFT size N_{DFT} representing a DFT size information D16 input by the clipping/non-contiguous allocation switching unit 11. The DFT unit 122 outputs the converted frequency domain signal to the clipping unit 123.

The clipping unit 123 performs the frequency clipping on the frequency domain signal input by the DFT unit 122 using the Nₛₜₐᵣₜ representing the clipping start position and the clipping number N_{clip} represented by the information D14 and D15 input by the clipping/non-contiguous allocation switching unit 11. Specifically, the clipping unit 123 removes the spectrum corresponding to the frequency resource from the Nₛₜₐᵣₜ number of the input frequency domain signal to the number as the result of Nₛₜₐᵣₜ+N_{clip}−1. The clipping unit 123 combines (allocating the spectrum values in allocation order, for example) the spectrum remaining after the removal (portion not removed), and outputs the spectrum having the combined resource number N_{alloc} to the mapping unit 124 as the frequency domain signal. Here, when the value of the input N_{clip} is zero, the clipping unit 123 does not perform the frequency clipping and outputs the frequency domain signal input by the clipping/non-contiguous allocation switching unit 11 to the mapping unit 124.

The mapping unit 124 allocates the frequency domain signal input by the clipping unit into the band used for transmission on the basis of the allocation information input by the control information receiving unit 100. The mapping unit 124 outputs the allocated signal to the IFFT (Inverse Fast Fourier Transform) unit 125.

The IFFT unit 125 converts the signal input by the mapping unit 124 into a time domain signal by IFFT of the FFT size corresponding to the system band. The IFFT unit 125 outputs the converted time domain signal to the reference signal multiplexing unit 127.

The reference signal multiplexing unit 127 multiplexes the time domain signal input by the IFFT unit and the reference signal (also referred to as RS: Reference Signal) generated by the reference signal generating unit 126. The reference signal multiplexing unit 127 outputs the multiplexed signal to the transmission processing unit 128.

The transmission processing unit 128 converts the signal input by the reference signal multiplexing unit 127 to an analog signal by inserting a CP (Cyclic Prefix (also referred to as Guard Interval (GI))) and performing a D/A (Digital to Analog) conversion, performs an upconversion to the wireless frequency band used for transmission, and transmits the signal processed thusly from the transmission antenna 129.

[Configuration of Receiving Device]

A non-linear repeating equalization technology is used as the receiving device 2 in order to restore a portion of the signal removed by the frequency clipping. As an example, the receiving device 2 uses the frequency domain SC/MMSE (Soft Canceller followed by Minimum Mean Square Error) turbo equalization technology.

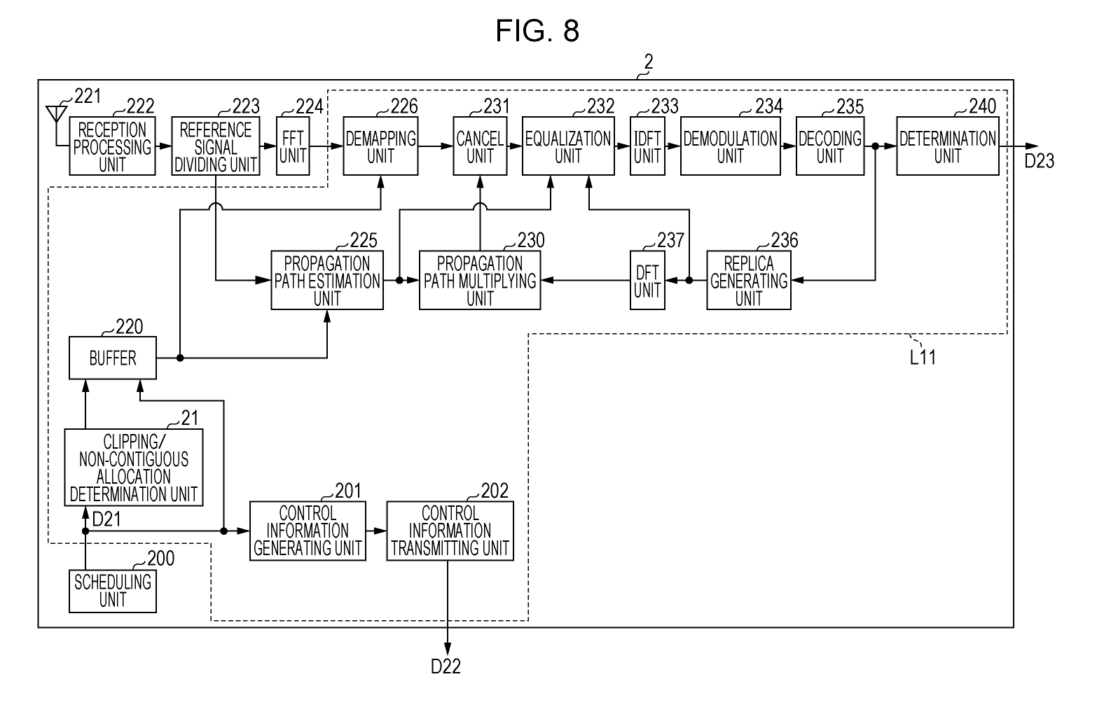

FIG. 8 is a schematic block diagram illustrating an example configuration of the receiving device 2 related to the first Embodiment.

The receiving device 2 is provisioned with a scheduling unit 200, a control information generating unit 201, a control information transmitting unit 202, a clipping/non-contiguous allocation determination unit 21, a buffer 220, a reception antenna 221, a reception processing unit 222, a reference signal dividing unit 223, an FFT unit 224, a propagation path estimating unit 225, a demapping unit 226, a propagation path multiplying unit 230, a cancel unit 231, an equalizing unit 232, an IDFT unit 233, a demodulation unit 234, a decoding unit 235, a replica generating unit 236, a DFT unit 237, and a determination unit 240.

Further, regarding the scheduling unit 200, the reception antenna 221, the reception processing unit 222, the reference signal dividing unit 223, and the FFT unit 224, a batch processing is performed regarding the first transmitting device 1-1 and the second transmitting device 1-2 which performs transmission with the receiving device 2, but processing is performed for each transmitting device 1 regarding the other configurations (block within a dotted line L11) to restore the data transmitted from each of the transmitting devices 1 as the receiving data.

A scheduling is performed at the receiving device 2 in order to first determine the band used by each of the transmitting devices 1 for transmission.

The scheduling unit 200 allocates wireless resources for the first transmitting device 1-1 and the second transmitting device 1-2 which performs transmission using the non-contiguous allocation or the contiguous allocation. The scheduling unit 200 generates an allocation information D21 representing the wireless resources allocated for each of the transmitting devices 1, and outputs the generated allocation information D21 to the control information generating unit 201, the clipping/non-contiguous allocation determination unit 21, and the buffer 220.

The control information generating unit 201 generates encoding ratio information and modulation method information (or MCS information) for each of the transmitting devices 1. The control information generating unit 201 generates control information including allocation information input by the scheduling unit 200, and the generated encoding ratio information and modulation method information for each of the transmitting devices 1. The control information generating unit 201 outputs the generated control information to the control information transmission unit 202.

The control information transmission unit 202 notifies the control information D22 for each of the transmitting devices 1 input by the control information generating unit 201 to these transmitting devices 1.

The clipping/non-contiguous allocation determination unit 21 generates the DFT size information representing the DFT size on the basis of the allocation information input by the scheduling unit 200, and outputs the generated DFT size information to the IDFT unit 233 and the DFT unit 237 (not illustrated). However, when the DFT size is identified by the size of the signal input into the IDFT unit 233 and the DFT unit 237, the clipping/non-contiguous allocation determination unit 21 may have a configuration that does not output the DFT size information. The clipping/non-contiguous allocation determination unit 21 determines whether or not the frequency clipping was performed on the received signal from each of the transmitting devices 1 using the allocation information input by the scheduling unit 200. The clipping/non-contiguous allocation determination unit 21 outputs a determination value k_{clip} as the determination result to the buffer 220.

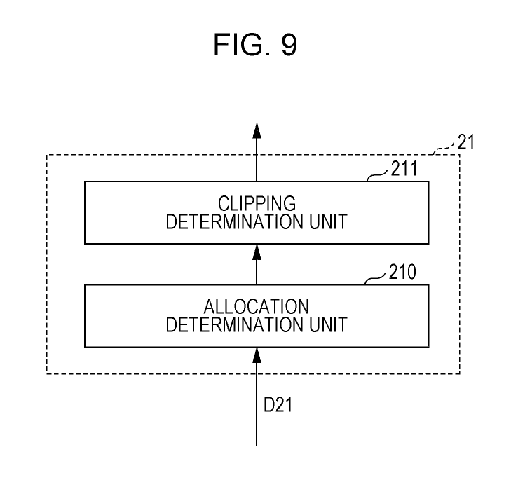

FIG. 9 is a schematic block diagram illustrating an example configuration of the clipping/non-contiguous allocation determination unit 21 related to the first Embodiment. The clipping/non-contiguous allocation determination unit 21 is provisioned with an allocation determination unit 210 and a clipping determination unit 211.

Similar to the allocation determination unit 110 in FIG. 6, the allocation determination unit 210 calculates the inter-cluster resource number Nᵢₙₜ and the total resource number N_{alloc} for all clusters on the basis of the allocation information D21 input by the scheduling unit 200. The allocation determination unit 210 outputs the information representing the calculated N_{alloc} and the Nᵢₙₜ to the clipping determination unit 211.

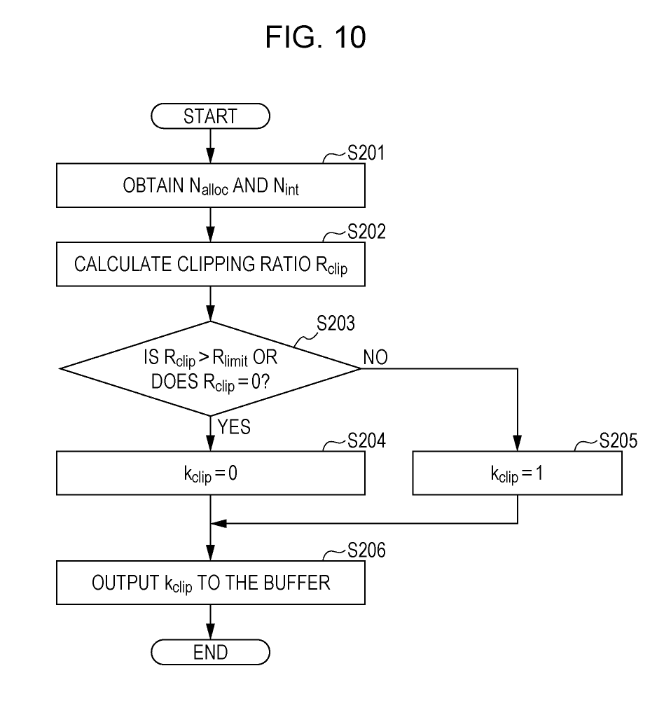

The clipping determination unit 211 performs the processing of the flowchart illustrated in FIG. 10 on the basis of the N_{alloc} and Nᵢₙₜ represented by the information input from the allocation determination unit 210. A determination is performed from this on whether or not the frequency clipping was performed on the received signal from each of the transmitting devices 1.

FIG. 10 is a flowchart illustrating an example of the operation of the clipping determination unit 211 related to the first Embodiment.

(Step S201) The clipping determination unit 211 obtains the information representing the N_{alloc} and Nᵢₙₜ for each of the transmitting devices 1 to be determined, from the allocation determination unit 210. Afterwards, processing proceeds to step S202.

(Step S202) The clipping determination unit 211 calculates the clipping ratio R_{clip} for performing the frequency clipping by substituting the N_{alloc} and Nᵢₙₜ represented by the information obtained at step S201 into the Expression (1). Afterwards, processing proceeds to step S203.

(Step S203) The clipping determination unit 211 determines whether or not the clipping ratio R_{clip} calculated at step S202 is larger than the previously stored threshold Rₗᵢₘᵢₜ (R_{clip} is greater than Rₗᵢₘᵢₜ), and whether or not the clipping ratio R_{clip} calculated at step S202 is zero (contiguous allocation). When the clipping ratio R_{clip} is larger than the threshold Rₗᵢₘᵢₜ, or when the clipping ratio R_{clip} is zero (Yes), the clipping determination unit 211 determines that the frequency clipping was not performed on the received signal from the transmitting device 1 being determined, and processing proceeds to step S204. Conversely, when the clipping ratio R_{clip} is at or below the threshold Rₗᵢₘᵢₜ and the clipping ratio R_{clip} is not zero (No), the clipping determination unit 211 determines that the frequency clipping was performed on the received signal from the transmitting device 1 being determined, and processing proceeds to step S205.

(Step S204) The clipping determination unit 211 substitutes a zero representing that the frequency clipping was not performed on the received signal from the transmitting device 1 being determined into the determination value k_{clip}. Afterwards, processing proceeds to step S206.

(Step S205) The clipping determination unit 211 substitutes a one representing that the frequency clipping was performed on the received signal from the transmitting device 1 being determined into the determination value k_{clip}. Afterwards, processing proceeds to step S206.

(Step S206) The clipping determination unit 211 outputs the determination value k_{clip} having the substituted value at either the step S204 or the step S205 to the buffer 220. Further, the determination value k_{clip} is information for each of the transmitting devices 1. The processing terminates after the clipping determination unit 211 has performed the operation in FIG. 10 for all of the transmitting devices 1.

By performing the processing as previously described, the clipping/non-contiguous allocation switching unit 21 is able to suitably switch between transmission by non-contiguous allocation and transmission by clipping. Also, the clipping/non-contiguous allocation determination unit 21 can make the same determination on whether or not to perform the frequency clipping for the transmission side and the reception side by making the same determination as the clipping/non-contiguous allocation determination unit 11. As a result, according to the wireless communication system, wireless resources needed for notification can be allocated to other communication and thus enabling an improvement in the transmission efficiency as compared to a case in which the information representing whether or not to perform the frequency clipping is notified.

Returning to FIG. 8, the buffer 220 temporarily stores the allocation information D21 input by the scheduling unit 200 and the determination value k_{clip} input by the clipping/non-contiguous allocation determination unit 21. Here, the buffer 220 stores the determination value k_{clip} for each of the transmitting devices 1 (identification information for the transmitting device 1; a terminal ID for example). The buffer 220 outputs the recorded allocation information and the determination value k_{clip} to the demapping unit 226 and the propagation path estimating unit 225 whenever the receiving device 2 receives a signal from the transmitting device 1, using this allocation information.

The reception processing unit 222 downconverts the signal received via the reception antenna 221 from the wireless frequency band. The reception processing unit 222 performs an A/D (Analog to Digital) conversion on the downconverted signal and removes the CP from the converted signal. The reception processing unit 222 outputs the signal processed thusly to the reference signal dividing unit 223.

The reference signal dividing unit 223 extracts the reference signal from the signal input by the reception processing unit 222, and outputs the extracted reference signal to the propagation path estimating unit 225. The reference signal dividing unit 223 outputs the signal from the signal input by the reception processing unit 222 without the reference signal to the FFT (Fast Fourier Transform: fast Fourier transform) unit 224.

The FFT unit 224 converts the signal input by the reception processing unit 222 into a frequency domain signal by FFT of the FFT size corresponding to the system band. The FFT unit 224 outputs the converted frequency domain signal to the demapping unit 226.

The demapping unit 226 divides the frequency domain signal input by the FFT unit 224 into signals for each of the transmitting devices 1 using the allocation information input by the buffer 220. The demapping unit 226 determines whether the value of the determination value k_{clip} input by the buffer 220 is a zero or a one for each of the transmitting devices 1, and performs the following processing depending on the determination result.

When the determination value k_{clip} is zero, the demapping unit 226 outputs the divided signal to the cancel unit 231. Conversely, when the determination value k_{clip} is one, the demapping unit 226 inserts a zero into the divided signal corresponding to the band corresponding to the inter-cluster portion between the first cluster and the second cluster represented by the allocation information input by the buffer 220. Specifically, the demapping unit 226 inserts a zero into the frequency resource from the Nₛₜₐᵣₜ number of the divided signal to the number as the result of Nₛₜₐᵣₜ+N_{clip}−1. The demapping unit 226 outputs the signal with the inserted zero to the cancel unit 231.

The propagation path estimating unit 225 calculates the estimated value (referred to as the propagation path estimation value) for the frequency response of the propagation path used in the transmission by each of the transmitting devices 1, using the allocation information input by the buffer 220 and the reference signal input by the reference signal dividing unit 223. The propagation path estimating unit 225 determines whether the value of the determination value k_{clip} input by the buffer 220 is a zero or a one, and performs the following processing depending on the determination result.

When the determination value k_{clip} is zero, the propagation path estimating unit 225 outputs the calculated propagation estimation value to the equalizing unit 232 and the propagation path multiplying unit 230. Conversely, when the determination value k_{clip} is one, the propagation path estimating unit 225 outputs the propagation path estimation value having a band frequency response corresponding to the clipping position of zero to the equalizing unit 232 and the propagation path multiplying unit 230, using the allocation information input by the buffer 220. That is to say, the receiving device 2 performs reception processing under the assumption that the spectrum to which the frequency clipping was performed is missing due to an absence of the frequency response when the determination value k_{clip} is one.

The propagation path multiplying unit 230 generates a receiving replica signal by multiplying the propagation path estimation value with the frequency domain replica signal input by the DFT unit 237 from the frequency domain SC/MMSE turbo equalization processing process. Regarding the frequency domain SC/MMSE turbo equalization processing, the processing of the cancel unit 231 described later, the equalizing unit 232, the IDFT (Inverse DFT: inverse discrete Fourier transform) unit 233, the demodulation unit 234, the decoding unit 235, the replica generating unit 236, the DFT unit 237, and the propagation path multiplying unit 230 are repeated for each of the transmitting devices 1 (referred to as “repeating processing”). The propagation path multiplying unit 230 outputs the generated receiving replica signal to the cancel unit 231.

The cancel unit 231 stores the signal input by the reception processing unit 222. The cancel unit 231 subtracts (cancels) the receiving replica input by the propagation path multiplying unit 230 from the stored signal. Further, the cancel unit 231 outputs the signal input by the reception processing unit 222 as it is (without cancelling) to the equalizing unit 232 regarding the first repetition of the repeating processing.

The equalizing unit 232 performs the equalization processing using the signal input by the cancel unit 231, the propagation path estimation value input by the propagation path estimating unit 225, and a soft replica input by the replica generating unit 236. Specifically, the equalizing unit 232 equalizes using the signal input by the cancel unit 231 and the propagation path estimation value input by the propagation path estimating unit 225, and reconfigures the desired signal by adding the soft replica to the equalized signal. The equalizing unit 232 outputs the equalized signal (desired signal) to the IDFT unit 233.

The IDFT unit 233 converts the signal input from the equalizing unit 232 into a time domain signal by performing IDFT. Here, the IDFT unit 233 performs IDFT at the DFT size N_{DFT} represented by the DFT size information input by the clipping/non-contiguous allocation determination unit 21.

The IDFT unit 233 outputs the converted time domain signal to the demodulation unit 234.

The demodulation unit 234 demodulates the time domain signal input by the IDFT unit 233, and calculates the LLR (Log Likelihood Ratio:log likelihood ratio) of the encoding bit. The demodulation unit 234 outputs the calculated LLR to the decoding unit 235.

The decoding unit 235 conducts the error correction decoding processing on the LLR input by the demodulation unit 234. As a result, the reliability of the LLR is improved. The decoding unit 235 counts an m number of repetitions regarding the repeating processing, and determines whether or not the counted m number of repetitions is a previously determined M number of repetitions.

When the determination result indicates that m is greater than or equal to M, the decoding unit 235 outputs the bit series that received the error correction decoding processing to the determination unit 240. Conversely, if the determination result indicates that m is less than M, the decoding unit 235 outputs the bit series which has received the error correction decoding processing to the replica generating unit 236.

However, when predetermined conditions such as errors not being detected, the repeating processing can be terminated regardless of whether the number of repetitions satisfied M.

The replica generating unit 236 generates the soft replica by performing the same processing as the encoding unit 120 and modulation unit 121 in the transmitting device 1 on the bit series input by the decoding unit 235. Here, the replica generating unit 236 uses the allocation information generated by the scheduling unit 200 for this processing. The replica generating unit 236 outputs the generated soft replica to the equalizing unit 232 and the DFT unit 237.

The DFT unit 237 generates the replica signal by converting the soft replica input by the replica generating unit 236 into a frequency domain signal by performing DFT. The DFT unit 237 outputs the generated replica signal to the propagation path multiplying unit 230.

The receiving device 2 repeats this kind of repeating equalization processing for an M number of repetitions for each of the transmitting devices 1. As a result, the receiving device 2 can improve the correcting capability for the error correction, and is able to procure a reliability due to the error correction on the signal band not transmitted due to the frequency clipping.

The determination unit 240 generates the data bits (bit series) by performing a hard determination on the LLR input by the decoding unit 235, and outputs the generated data bits as a received data D23.

In this way, according to the first Embodiment, the receiving device 2 transmits the allocation information (control information) representing the frequency band used in the transmission of the data by the transmitting device 1 to the transmitting device 1. The transmitting device 1 determines whether or not the frequency clipping was performed to remove a portion of the spectrum from the transmission signal. Also, the receiving device 2 determines whether or not the frequency clipping was performed to remove a portion of the spectrum from the signal transmitted by the transmitting device 1. As a result, regarding the wireless communication system according to the first Embodiment, despite not transmitting information representing whether or not the frequency clipping was performed, whether or not the frequency clipping was performed can be determined, a decrease in the transmission efficiency can be prevented, and the frequency clipping can be performed. That is to say, the frequency clipping as disclosed in the PTL 1 can be implemented in wireless communication systems performing the non-contiguous allocation as in the NPL 1, and an increase in the amount of control information can be prevented from performing a switching between the non-contiguous allocation and clipping using the allocation information of the same format.

Also, according to the first Embodiment, the control information is information representing that the spectrum of the signal transmitted by the first communications device is allocated non-contiguously in the frequencies. As a result, regarding the wireless communication system according to the first Embodiment, the frequency clipping and the non-contiguous allocation can be switched.

Also, according to the first Embodiment, the transmitting device 1 determines whether or not the frequency clipping was performed on the basis of whether or not the frequency band represented by the allocation information satisfies predetermined conditions. That is to say, the transmitting device 1 determines that the frequency clipping was performed when the clipping ratio R_{clip} that can be calculated from the system band represented by the allocation information is smaller than the threshold Rₗᵢₘᵢₜ, and determines that the frequency clipping has not been performed when the R_{clip} is larger than the threshold Rₗᵢₘᵢₜ. Here, the clipping ratio R_{clip} is the ratio that can be calculated when the frequency band represented by the allocation information is divided into multiple clusters and allocated into a non-contiguous allocation, and when the entire band between the clusters is lost due to clipping. As a result, according to the first Embodiment, the wireless communication system can maximize transmission throughput by designating the clipping ratio R_{clip} that is equivalent to the non-contiguous allocation transmission throughput and the frequency clipping transmission throughput as the threshold Rₗᵢₘᵢₜ.

<First Modification>

According to the first Embodiment, the form has been illustrated when the maximum cluster number is two, but a similar processing can be performed when the maximum cluster number is three or more.

In this case, the allocation information corresponds one bit of the allocation information having a bit length of N_{RBG} to all RBGs within the system band in which an N_{RBG} number of RBGs are present, for example, and utilizes a bit map method performing an allocation on only the RBG in which this bit is one.

Also, the allocation information may have a one-to-one correspondence between the combination of the index information for both ends of all clusters as disclosed in the NPL 1 and the bit sequence, for example. However, the bit length N_{RA} (N_{CL}) of the allocation information used when the maximum cluster number is N_{CL} regarding the latter is expressed by the following Expression (3).

N_{RA}(N_{CL})=ceil(log₂(conbin(N_{RBG}+1,2N_{CL}))) (3)

where the ceil(x) represents the minimum integer that is at least x, and the conbin(A, B) represents the sum of the combination of selecting a B number from the total A.

Using the allocation information as described beforehand, the allocation starting position Iₛₜₐᵣₜ(n) and I_{end}(n) (where 1≦n≦N_{CL}) is recognized at both the transmitting device 1 and the receiving device 2. In this case, a bandwidth N(n) for an n number of clusters is represented as N(n)=I_{end}(n)−Iₛₜₐᵣₜ(n)+1 (where 1≦n≦N_{CL}), and a bandwidth Nᵢₙₜ(n) between an n+1 number of clusters and the n number of clusters is represented as Nᵢₙₜ(n)=I_{end}(n+1)−Iₛₜₐᵣₜ)n)−1 (where 1≦n≦N_{CL}−1).

The clipping/non-contiguous allocation determination unit 11 and the clipping/non-contiguous allocation determination unit 21 calculate the DFT size N_{DFT} using the following Expression (4) when it is determined that the frequency clipping was not performed.

$${N}_{DFT} = {\sum }_{n = 1}^{{N}_{CL}} N ( n ) \qquad ( 4 )$$

The transmitting device 1 generates the frequency domain signal by DFT of this DFT size N_{DFT}, divides the spectrum for the generated frequency domain signal into clusters, and performs the non-contiguous allocation to each allocation band.

Conversely, the clipping/non-contiguous allocation determination unit 11 and the clipping/non-contiguous allocation determination unit 21 calculate the DFT size N_{DFT} using the following Expression (5) when not performing the frequency clipping between all clusters, for example, when it is determined that frequency was not performed.

$${N}_{C\_DFT } = {N}_{DFT} + {\sum }_{n = 1}^{{N}_{CL} - 1} {N}_{int} ( n ) \qquad ( 5 )$$

Here, as the band corresponding to the inter-cluster portion was removed by clipping, the clipping/non-contiguous allocation determination unit 11 and the clipping/non-contiguous allocation determination unit 21 calculate the clipping ratio R_{clip} by the following Expression (6).

$${R}_{clip} = \frac{{\sum }_{n = 1}^{{N}_{CL} - 1} {N}_{int} ( n )}{{N}_{C\_DFT}} \qquad ( 6 )$$

The R_{clip} calculated using the Expression (6) and the threshold Rₗᵢₘᵢₜ are compared by the clipping/non-contiguous allocation determination unit 11 at the step S103 in FIG. 7 and by the clipping/non-contiguous allocation determination unit 21 at the step S203 in FIG. 10. As a result, according to the wireless communication system, the clipping and the non-contiguous allocation can be switched even when the maximum cluster number is three or more.

<Example of Second Modification>

According to the wireless communication system, either one of or both of the transmitting device and the receiving device can perform communication by MIMO (Multiple Input Multiple Output) using multiple antennae.

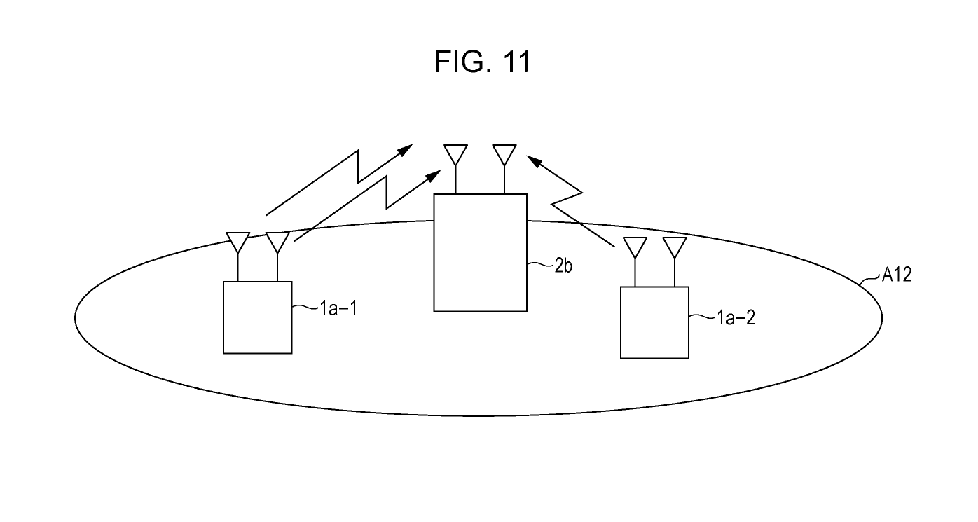

FIG. 11 is a schematic diagram illustrating an example wireless communication system related to the second modification. The wireless communication system in FIG. 11 is different from the wireless communication system in FIG. 4 in that the first transmitting device 1a-1 and the second transmitting device 1a-2 (together form the transmitting device 1a), and the receiving device 2a are provisioned with multiple antennae. The first transmitting device 1a-1, the second transmitting device 1a-2, and a receiving device 2b are present in the area called cell A12 in FIG. 11.

Hereafter, the first transmitting device 1-1a and the second transmitting device 1a-2 are referred to as the transmitting device 1a, and the receiving device 2 is referred to the receiving device 2a.

[Configuration of Transmitting Device]

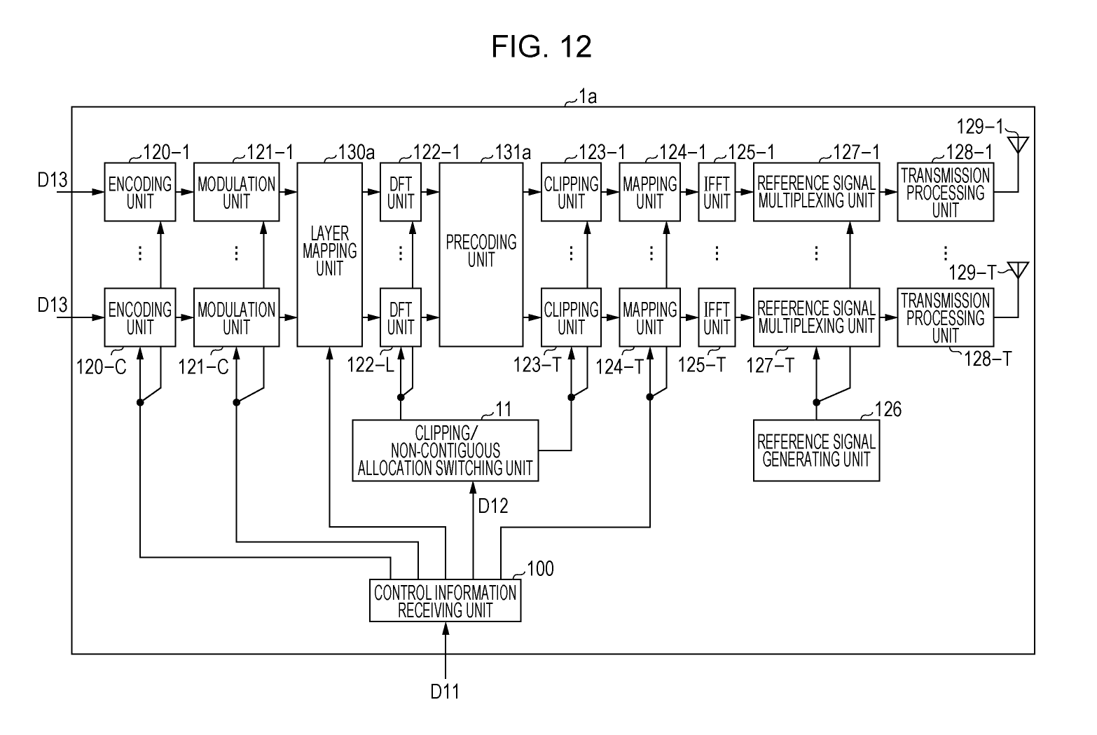

FIG. 12 is a schematic block diagram illustrating an example configuration of the transmitting device 1a related to the second modification. The transmitting device 1a is provisioned with the control information receiving unit 100, the clipping/non-contiguous allocation determination unit 11, an encoding unit 120-1 through 120-C, a modulation unit 121-1 through 121-C, a layer mapping unit 130a, a DFT unit 122-1 through 122-L, a precoding unit 131a, a clipping unit 123-1 through 123-T, a mapping unit 124-1 through 124-T, an IFFT unit 125-1 through 125-T, a reference signal generating unit 126, a reference signal multiplexing unit 127-1 through 127-T, a transmission processing unit 128-1 through 128-T, and a transmission antenna 129-1 through 129-T. Here C is a code word number, L is a rank (also referred to as Rank or layer number) representing a stream number transmitted simultaneously, and T represents the number of transmission antennae.

The processing performed by the clipping/non-contiguous allocation determination unit 11 the encoding unit 120-1 through 120-C, the modulation unit 121-1 through 121-C, the DFT unit 122-1 through 122-L, the clipping unit 123-1 through 123-T, the mapping unit 124-1 through 124-T, the IFFT unit 125-1 through 125-T, the reference signal multiplexing unit 127-1 through 127-T, the transmission processing unit 128-1 through 128-T, and the transmission antenna 129-1 through 129-T is similar to that of the encoding unit 120, the modulation unit 121, the DFT unit 122, the clipping unit 123, the mapping unit 124, the IFFT unit 125, the reference signal multiplexing unit 127, the transmission processing unit 128, and the transmission antenna 129, and so their description is omitted.

The control information receiving unit 100 receives the control information D11 notified by the receiving device, outputs the encoding ratio information from this control information D11 to the encoding unit 120-1 through 120-C, outputs the modulation method information to the modulation unit 121-1 through 121-C, and outputs the allocation information D12 to the clipping/non-contiguous allocation determination unit 11 and the mapping unit 124.

The layer mapping unit 130a maps the modulation signal input by the modulation unit 121-1 through 121-C to each layer depending on the rank L represented by the rank information input by the control information receiving unit 100. The layer mapping unit 130a outputs the modulated signal mapped to layer I (I=1 through L) to the DFT unit 122-I.

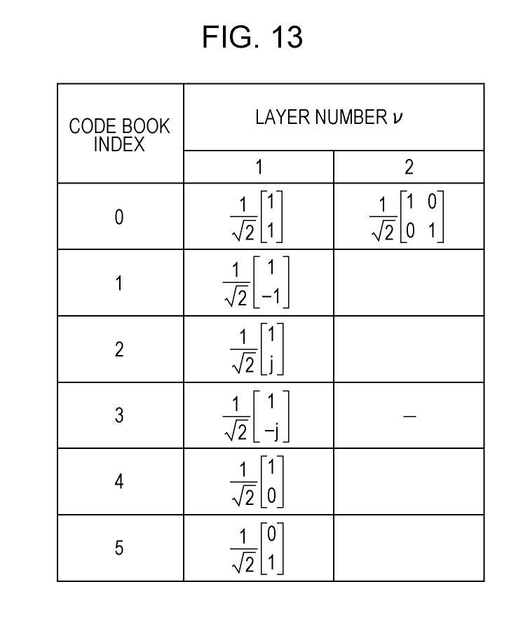

The precoding unit 131a multiplies a previously determined precoding matrix against the signal input by the DFT unit 122-1 through 122-L when the rank L represented by the rank information is lower than the transmission antenna number T of the transmission device 1a. The illustration here is when the transmission antenna number is two. A number of layers ν (Number of ν layers) is the layer number that is to say, the rank. When the number of layers ν is one, one stream of signal is transmitted using two transmission antennae, and when this is two, two streams of signal are transmitted. A codebook index is an index used when notification to the mobile station device which matrix to use. However, the prepared candidate precoding matrix is not limited to that in FIG. 13, and any different number of precoding matrices can be prepared.

Here, we will describe a case when using a rank 1 precoding matrix. As the precoding matrix w illustrated in FIG. 13 is multiplied against the transmission signal of one stream as in the following expression according to rank 1, the receiving signal regarding the k number frequency is expressed by the following Expression (7).

R(k)=h(k)wS(k)+η(k) (7)

However, S(k) is the bandwidth of the transmission signal expressed as multiple prime numbers of the k number frequency domain, η(k) is the noise including the interference from neighboring cells, R(k) is the bandwidth of the receiving signal, and w is one matrix selected from the precoding matrices for one number of layers illustrated in FIG. 13. Also, h(k) is the propagation path matrix expressed as 1×2, and is expressed by the following Expression (8).

h(k)=[h₁(k),h₂(k)] (8)

However, the h₁(k) is the propagation path property expressed as multiple prime numbers of the k number frequency from the first transmission antenna to the receiving antenna, and h₂(k) is propagation path property from the second transmission antenna expressed as multiple prime numbers of the k number frequency to the receiving antenna. Therefore, the power advantage of the k number frequency expressed in this way is expressed by the following Expression (9).

P(k)=|h(k)w|² (9)

However, P(k) represents the power advantage regarding the transmission signal expressed as real numbers of the k number frequency. The receiving device determines the frequency allocation on the basis of the Expression (3).

Returning to FIG. 12, the precoding unit 131a outputs the signal allocated to the transmission antenna 129-t (t=1 through T) from the signal in which precoding was performed to the clipping unit 123-t. As a result, according to the wireless communication system, a diversity effect can be obtained between multiple transmission antennae.

Conversely, the precoding unit 131a outputs the signal input by the DFT unit 122-I to the clipping unit 123-I when the rank L represented by the rank information is the same or higher than the transmission antenna number T for the transmission device 1a.

The reference signal generating unit 126 generates the reference signal transmitted from the multiple transmission antennae so that it is divisible at the receiving device, and then outputs this to the reference signal multiplexing unit 127-1 through 127-T.

[Configuration of Receiving Device]

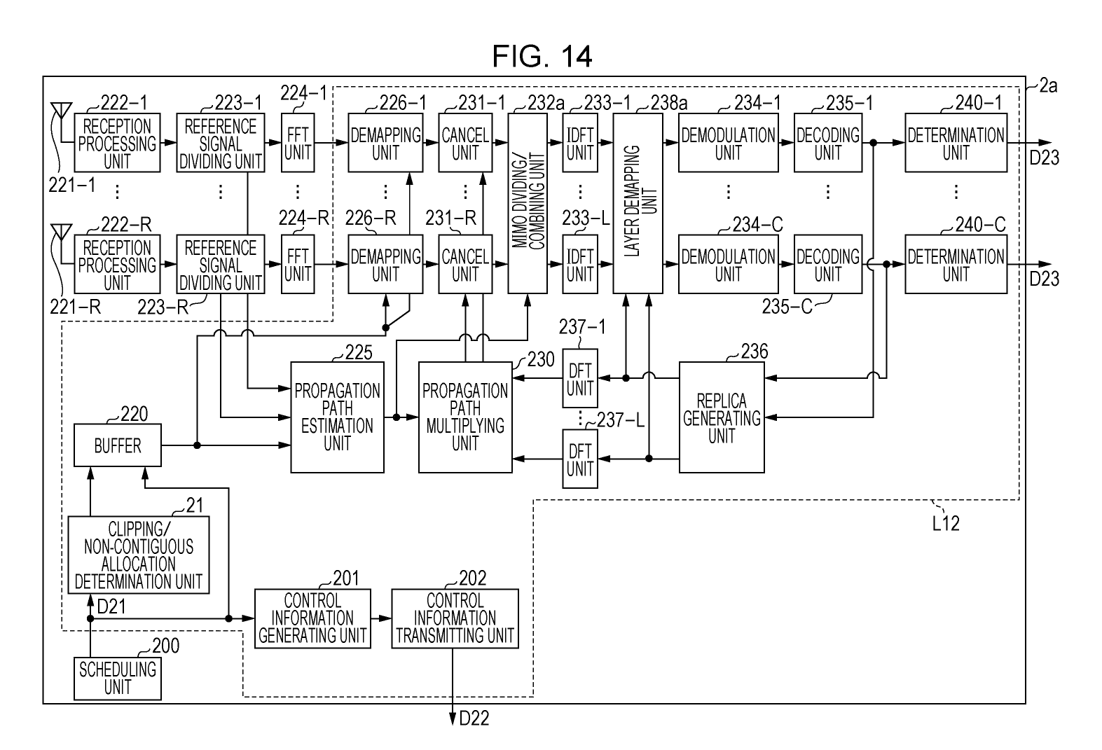

FIG. 14 is a schematic block diagram illustrating an example of the receiving device 2a related to the second modification. The receiving device 2a is provisioned with the scheduling unit 200, the control information generating unit 201, the control information transmission unit 202, the clipping/non-contiguous allocation determination unit 21, the buffer 220, a reception antenna 221-1 through 221-R, a reception processing unit 222-1 through 222-R, a reference signal dividing unit 223-1 through 223-R, an FFT unit 224-1 through 224-R, the propagation path estimating unit 225, a demapping unit 226-1 through 226-R, the propagation path multiplying unit 230, a cancel unit 231-1 through 231-R, an MIMO dividing/combining unit 232a, an IDFT unit 233-1 through 233-L, a layer demapping unit 238a, a demodulation unit 234-1 through 234-C, a decoding unit 235-1 through 235-C, the replica generating unit 236, a DFT unit 237-1 through 237-T, and a determination unit 240-1 through 240C. Also, regarding the block within a dashed line L12, processing is performed for each of the transmitting devices 1a, and the transmitted data from each is restored as the received data.

The processing performed by the scheduling unit 200, the control information generating unit 201, the control information transmission unit 202, the clipping/non-contiguous allocation determination unit 21, the buffer 220, the reception antenna 221-1 through 221-R, the reception processing unit 222-1 through 222-R, the reference signal dividing unit 223-1 through 223-R, the FFT unit 224-1 through 224-R, the demapping unit 226-1 through 226-R, the cancel unit 231-1 through 231-R, the IDFT unit 233-1 through 233-L, the demodulation unit 234-1 through 234-C, the decoding unit 235-1 through 235-C, the DFT unit 237-1 through 237-T, and the determination unit 240-1 through 240-C are the same as that of the scheduling unit 200, the control information generating unit 201, the control information transmission unit 202, the clipping/non-contiguous allocation determination unit 21, the buffer 220, the reception antenna 221, the reception processing unit 222, the reference signal dividing unit 223, the FFT unit 224, the demapping unit 226, the cancel unit 231, the IDFT unit 233, the demodulation unit 234, the decoding unit 235, the DFT unit, and the determination unit 240, and so their description is omitted.

The propagation path estimating unit 225 calculates the estimated value for the frequency response of the propagation path (propagation estimation value) from each of the transmission antennae 129-1 through 129-T through each of the reception antennae 221-1 through 221-R on the receiving device 2a, using the allocation information input by the buffer 220 and the reference signal for each of the reception antennae 221-r input by the reference signal dividing unit 223-r (r=1 through R). The propagation path estimating unit 225 determines whether the value of the determination value k_{clip} input by the buffer 220 is a zero or a one, and performs the following processing depending on the determination result.

When the determination value k_{clip} is zero, the propagation path estimating unit 225 outputs the information representing the propagation matrix for the calculated propagation estimation value to the MIMO dividing/combining unit 232a. The propagation matrix is a matrix in which the propagation estimation value from the transmission antennae 129-t through the reception antennae 221-r is allocated in an r number of rows and at number of columns.

Conversely, when the determination value k_{clip} is one, the propagation path estimating unit 225 outputs the information representing the propagation matrix for the propagation estimation value, in which the frequency response corresponding to the clipping position (inter-cluster resource) is designated as zero using the allocation information input by the buffer 220, to the MIMO dividing/combining unit 232a. That is to say, when the determination value k_{clip} is one, the receiving device 2 performs the receiving processing assuming that the spectrum to which the frequency clipping was performed is lost due to the lack of the frequency response.

The propagation path multiplying unit 230 generates the replica signal for each of the reception antennae 221-r by multiplying the propagation estimation value input by the propagation path estimating unit 225 with the replica signal for each layer input by the DFT units 237-1 through 237-L. The propagation path multiplying unit 230 outputs the generated replica signal for the reception antennae 221-r to the cancel units 231-r.

The MIMO dividing/combining unit 232a performs the restoring and combining of the signal for each layer using the signal input by the cancel units 231-1 through 231-R, the propagation matrix represented by the information input by the propagation path estimating unit 225, and the soft replica input by the replica generating unit 236. The MIMO dividing/combining unit 232a outputs the layer I signal resulting after the restoring and combining to the IDFT unit 233-I.

The layer demapping unit 238a restores the desired signal for each layer I by adding the soft replica for the layer I input by the replica generating unit 236 to the signal input by the IDFT unit 233-I. The layer demapping unit 238a divides the signal for each code word c (c=1 through C) by a reverse mapping to that by the layer mapping unit 130a of the restored layer I signal (desired signal). The layer demapping unit 238a outputs the code word c signal resulting after the division to the demodulation units 234-c.

The replica generating unit 236 generates the soft replica for the layers 1 through L by performing a similar processing as that by the encoding unit 120, the modulation unit 121, and the layer mapping unit 130a in the transmitting device 1a on the bit sequence input by the decoding unit 235. The replica generating unit 236 outputs the generated soft replica for the layers 1 through L to the layer demapping unit 238a, and outputs the soft replica for the layer I to the DFT unit 237-I.

In this way, according to the first Embodiment, the wireless communication system can determine whether or not the frequency clipping was performed even when information representing whether or not the frequency clipping was performed is not transmitted for cases performing communication by MIMO transmission, and the frequency clipping can be performed while preventing a decrease in transmission efficiency.

### Second Embodiment

Hereafter, the second Embodiment of the present invention will be described in detail with reference to the drawings.

According to the wireless communication system related to the second Embodiment, the threshold Rₗᵢₘᵢₜ for the clipping ratio is changed using information known by both the a transmitting device 1b and a receiving device 2b. Here, the information known by both devices will be described for a case in which the threshold is determined on the basis of an MCS representing the combination of the modulation method, the error correction encoding, and the encoding ratio from the control information notified between the transmitting device 1b and the receiving device 2b. However, the present invention is not limited to the second Embodiment, and so the threshold Rₗᵢₘᵢₜ can be changed on the basis of other information. Also, either one of or both of the transmitting device 1b and the receiving device 2b can notify the information representing the threshold Rₗᵢₘᵢₜ for the clipping ratio to the communication party.

The wireless communication system according to the first Embodiment described beforehand was described in which the threshold Rₗᵢₘᵢₜ used to satisfy the Expression (2) as an example of the threshold Rₗᵢₘᵢₜ. Here, an expected value E (FER_{D}) for the frame error ratio when using the non-contiguous allocation and an expected value E (FER_{C} (R_{clip})) when using clipping at the clipping ratio R_{clip} take different values for communication parameters such as the modulation method and the error coding ratio for error correction. Particularly with regard to the frame error ration when using clipping, as turbo equalization technologies are used when using a high encoding ratio and modulation method, the restoration of the clipped spectrum is difficult, which can lead to increased degradation as compared with the error ratio regarding the non-contiguous allocation.

The wireless communication system according to the second Embodiment sets allowed clipping ratio, that is to say, the threshold Rₗᵢₘᵢₜ for switching between the non-contiguous allocation and clipping, to a lower values the more values there are for the modulation method and the higher the encoding ratio.

As an example of the setting criteria for the threshold Rₗᵢₘᵢₜ, a clipping ratio that keeps the degradation amount of the frame error ratio from clipping within a constant value can be used when using an MCS index I_{MCS}. That is to say, the Rₗᵢₘᵢₜ is set by the following Expression (10) when a required SNR for satisfying a frame error ratio FER_{allow} is designated as SNR (FER_{allow}, I_{MCS}, R_{clip}) when the MCS is I_{MCS} and the clipping ratio is R_{clip}.

SNR(FER_{allow},I_{MCS},Rₗᵢₘᵢₜ)−SNR(FER_{allow},I_{MCS},0)<D (10)

Here, D is the allowed degradation amount of the required SNR, and can be either a previously determined value or can be set to an optional value as necessary. Also, either one of or both of the transmitting device 1b and receiving device 2b can notify this D and the threshold Rₗᵢₘᵢₜ for the clipping ratio to the communication party.

Also, as another example of the setting criteria for the threshold Rₗᵢₘᵢₜ, a clipping ratio can be used so that the estimated value for the throughput for clipping is better than the estimated value for the throughput for the non-contiguous allocation when using the MCS index I_{MCS}. However, the optimal MCS should be different when using clipping and when using the non-contiguous allocation, and so the threshold Rₗᵢₘᵢₜ can be set to the frequency clipping ratio, in which the estimated value for the throughput when performing the frequency clipping using the MCS which equals I_{MCS} is better than the throughput when performing the non-contiguous allocation using an arbitrary MCS, when the MCS is the I_{MCS}.

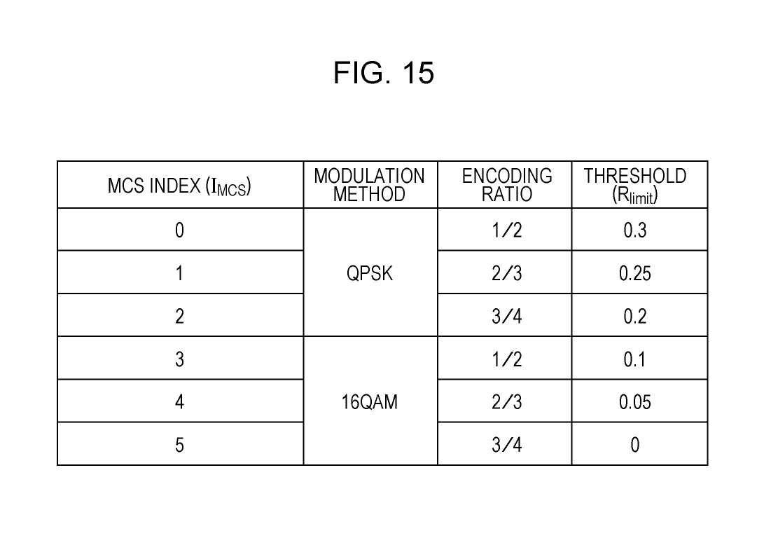

FIG. 15 is a schematic diagram illustrating an example of a threshold table related to the second Embodiment according to the present invention. The threshold table is a table corresponding the MCS index I_{MCS} and the threshold Rₗᵢₘᵢₜ.

The values 0 through 2 under the I_{MCS} in FIG. 15 correspond to the modulation method QPSK and is the index when the encoding ratio for error correction is 1/2, 2/3, and 3/4.

The values 3 through 4 under the I_{MCS} correspond to the modulation method 16QAM and is the index when the encoding ratio for error correction is 1/2, 2/3, and 3/4. The threshold Rₗᵢₘᵢₜ is applied to these six MCS index values 0 through 5 resulting in Rₗᵢₘᵢₜ values of 0.3, 0.25, 0.2, 0.1, 0.05, and 0, respectively.

For example, when the I_{MCS} is zero, the encoding ratio is 1/2 and the modulation method is QPSK resulting in an Rₗᵢₘᵢₜ of 0.3, and so the frequency clipping is allowed when the clipping ratio is within 0.3. Also for example, when the I_{MCS} is five, the encoding ratio is 3/4 and the modulation method is 16QAM resulting in an Rₗᵢₘᵢₜ of 0, and so the frequency clipping is not allowed.

FIG. 15 illustrates that the value of the threshold Rₗᵢₘᵢₜ decreases as the values of the I_{MCS} index increase, and illustrates that the value of the threshold Rₗᵢₘᵢₜ increases as the values of the I_{MCS} index decrease. Also, FIG. 15 illustrates that the value of the threshold Rₗᵢₘᵢₜ decreases as the modulation symbols increase, and illustrates the value of the threshold Rₗᵢₘᵢₜ increases as the modulation symbols decrease. Also, FIG. 15 illustrates that the value of the threshold Rₗᵢₘᵢₜ decreases as the encoding ratio increases, and illustrates that the value of the threshold Rₗᵢₘᵢₜ increases as the encoding ratio decreases.

[Configuration of Transmitting Device]

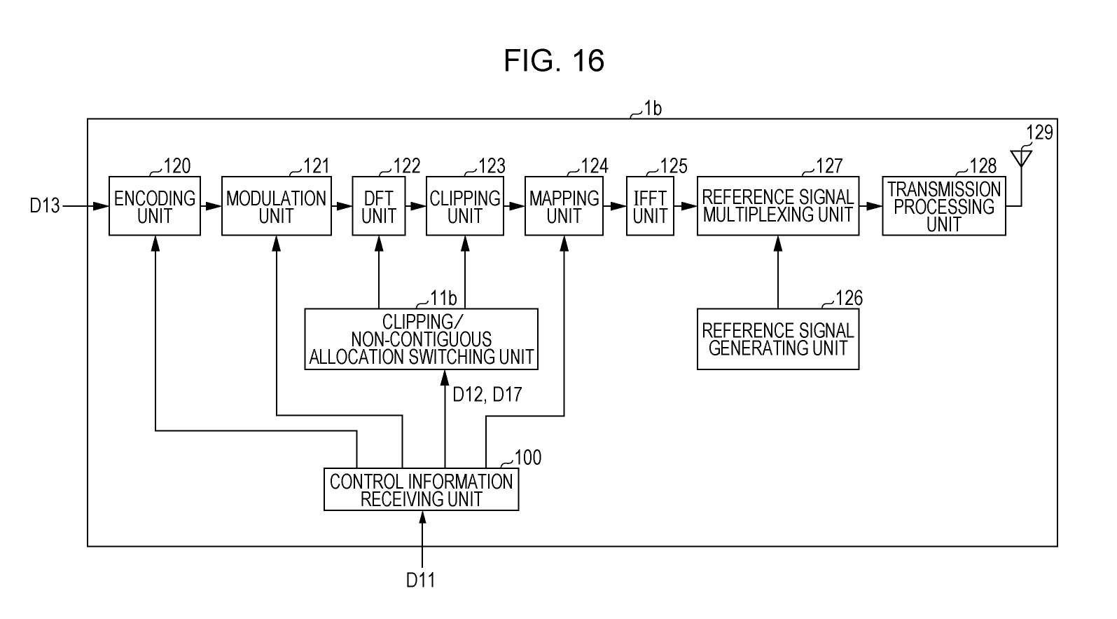

FIG. 16 is a schematic block diagram illustrating an example configuration of the transmitting device 1b related to the second Embodiment.

The transmitting device 1b is different in that the clipping/non-contiguous allocation determination unit 11 in the transmission device 1 as in FIG. 5 is replaced with a clipping/non-contiguous allocation determination unit 11b. Specifically, an MCS information D17 is input into the clipping/non-contiguous allocation determination unit 11b in addition to the allocation information from the control information receiving unit 100. The other configurations of the transmitting device 1b in FIG. 16 perform a similar processing to the transmission device 1 in FIG. 5 and have the same reference numerals, and so their description is omitted.

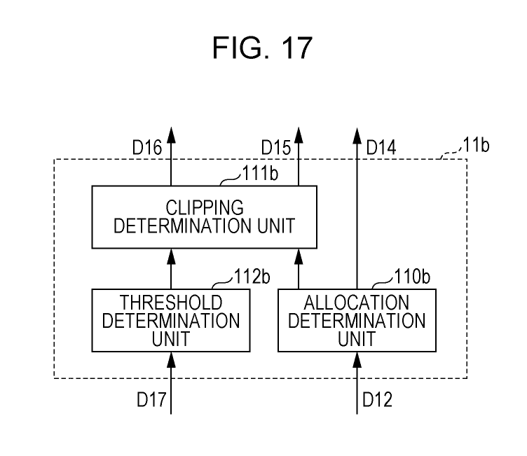

FIG. 17 is a schematic block diagram illustrating an example configuration of the clipping/non-contiguous allocation determination unit 11b related to the second Embodiment. The clipping/non-contiguous allocation determination unit 11b is provisioned with a threshold determination unit 112b, an allocation determination unit 110b, and a clipping determination unit 111b.

The threshold determination unit 112b stores the threshold table corresponding the threshold (Rₗᵢₘᵢₜ) and the MCS index (I_{MCS}) as illustrated in FIG. 15. The threshold determination unit 112b determines the threshold Rₗᵢₘᵢₜ (I_{MCS}) on the basis of the MCS information D17 input by the control information receiving unit 100 in FIG. 12 and the stored threshold table, and outputs the determined threshold Rₗᵢₘᵢₜ (I_{MCS}) to the clipping determination unit 111b.

The allocation determination unit 110b performs a similar processing as the allocation determination unit 110 in FIG. 6, and so its description is omitted.

The clipping determination unit 111b performs a determination on whether or not to perform the frequency clipping by performing the processing in the flowchart illustrated in FIG. 7. However, the clipping determination unit 111b uses the Rₗᵢₘᵢₜ (I_{MCS}) input by the 112b in addition the threshold Rₗᵢₘᵢₜ at the step S103 in FIG. 7.

Specifically, the clipping determination unit 111b performs the following operation. After obtaining the inter-cluster resource number Nᵢₙₜ and the allocation resource number N_{alloc} from the allocation determination unit 110b, the clipping determination unit 111b calculates the clipping ratio R_{clip} to perform the frequency clipping by the Expression (1).

The clipping determination unit 111b determines not to perform the frequency clipping when the R_{clip} is greater than the Rₗᵢₘᵢₜ (I_{MCS}) (clipping ratio is over the threshold) and when the R_{clip} equals zero (allocation is a contiguous allocation). In this case, the clipping determination unit 111b inserts the value of N_{alloc} into the DFT size N_{DFT}, and inserts a zero into the clipping number N_{clip}.

The clipping determination unit 111b determines to perform the frequency clipping in all other cases, substitutes the value of N_{alloc} plus Nᵢₙₜ into the DFT size N_{DFT}, and substitutes the value of Nᵢₙₜ into the clipping number N_{clip}.

The clipping determination unit 111b outputs the DFT size information representing the DFT size N_{DFT} to the DFT unit 122, outputs the clipping number N_{clip} to the clipping unit 123, and the processing terminates. However, the order of the output to the DFT unit 122 and the output to the clipping unit 123 can be reversed.

By performing the processing as described beforehand, the clipping/non-contiguous allocation determination unit 11b can suitably switch between transmission by the non-contiguous allocation and transmission by the frequency clipping using the threshold which is different for each MCS.

[Configuration of Receiving Device]

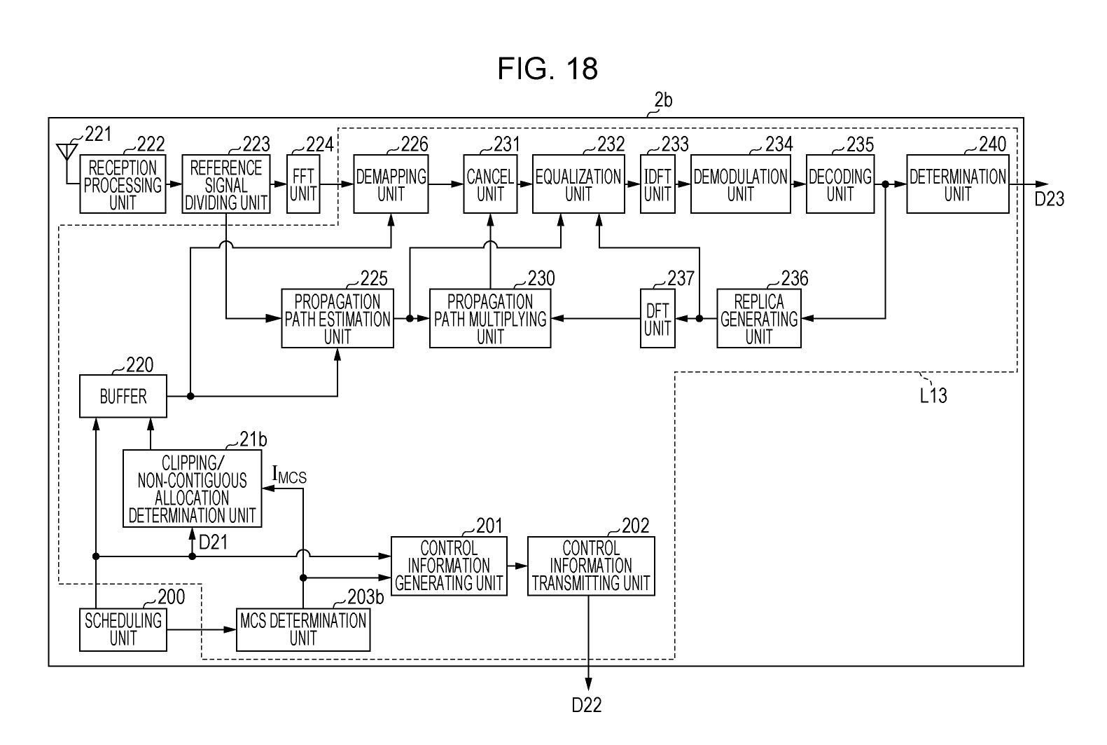

FIG. 18 is a schematic block diagram illustrating an example configuration of the receiving device 2b related to the second Embodiment. The area enclosed by a dashed line L13 represents that the same processing is performed in parallel for each of the transmission devices 1b. Processing is performed in the configuration (block) within the dashed line L13 for each of the transmission devices 1b, and the data transmitted by each of the transmission devices 1b are restored as the received data.

The receiving device 2b is different in that an MCS determination unit 203b is further provisioned to the receiving device 2 in FIG. 8, and the clipping/non-contiguous allocation determination unit 21 is replaced by a clipping/non-contiguous allocation determination unit 21b. The other configurations in the receiving device 2b in FIG. 18 perform the same processing as that of the receiving device 2 in FIG. 8 and have the same reference numerals, and so the description of this processing is omitted.

The MCS determination unit 203b estimates the SINR (Signal to Interference and Noise Power Ratio) for the band used in transmission by the corresponding transmitting device 1b on the basis of the propagation path property and the allocation information D21 input by the scheduling unit 200. The MCS determination unit 203b determines the optimal modulation method and encoding ratio for transmission, that is to say, the MCS, on the basis of the estimated SINK. The MCS determination unit 203b outputs the MCS index I_{MCS} representing the determined MCS to the clipping/non-contiguous allocation determination unit 21b and the control information generating unit 201.

The clipping/non-contiguous allocation determination unit 21b generates the DFT size information representing the DFT size on the basis of the allocation information D21 input by the scheduling unit 200, and outputs the generated DFT size information to the IDFT unit 233 and the DFT unit 237. The clipping/non-contiguous allocation determination unit 21b determines whether or not the frequency clipping was performed on the received signal from each of the transmission devices 1b using the MCS index I_{MCS} input by the MCS determination unit and the allocation information D21 input by the scheduling unit 200. The clipping/non-contiguous allocation determination unit 21b outputs the determination value k_{clip} as the determination result to the buffer 220.

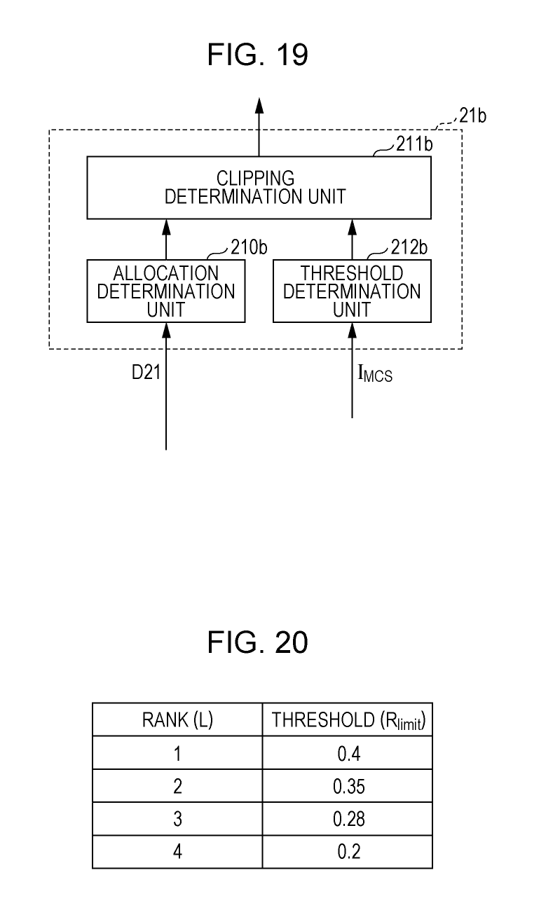

FIG. 19 is a schematic block diagram illustrating an example configuration of the clipping/non-contiguous allocation determination unit 21b related to the second Embodiment. The clipping/non-contiguous allocation determination unit 21b is provisioned with an allocation determination unit 210b, a clipping determination unit 211b, and a threshold determination unit 212b.

The allocation determination unit 210b includes the same functionality as the allocation determination unit 210 in FIG. 9. The allocation determination unit 210b outputs the information representing the calculated N_{alloc} and Nᵢₙₜ to the clipping determination unit 111.

The threshold determination unit 212b stores the same threshold table as that of the threshold determination unit 112b in the transmission device in FIG. 17 (FIG. 15). The threshold determination unit 212b determines the threshold Rₗᵢₘᵢₜ (I_{MCS}) on the basis of the MCS index I_{MCS} input by the MCS determination unit 203b and the stored threshold table, and outputs the determined threshold Rₗᵢₘᵢₜ (I_{MCS}) to the clipping determination unit 211b.

The clipping determination unit 211b determines whether or not the frequency clipping was performed on the received signal from each of the transmission devices 1b by performing the processing in the flowchart illustrated in FIG. 10 similar to that by the clipping determination unit 211 in FIG. 9. However, the clipping determination unit 211b uses the Rₗᵢₘᵢₜ (I_{MCS}) input by the threshold determination unit 212b in addition to the threshold Rₗᵢₘᵢₜ at the step S103 in FIG. 10.

Specifically, the clipping determination unit 211b performs the following processing. After obtaining the allocation resource number N_{alloc} and the inter-cluster resource number Nᵢₙₜ from the allocation determination unit 210b, the clipping determination unit 211b calculates the clipping ratio R_{clip} when the frequency clipping was performed by the Expression (1).

The clipping determination unit 211b determines that the frequency clipping was not performed when the R_{clip} is greater than the Rₗᵢₘᵢₜ (I_{MCS}) (clipping ratio is over the threshold) and when R_{clip} equals zero (allocation is the contiguous allocation). In this case, the clipping determination unit 211b substitutes a zero into the determination value k_{clip}.

The clipping determination unit 211b determines that the frequency clipping was performed for all other cases, and substitutes a one in the determination value k_{clip}.

The clipping determination unit 211b outputs the determination value k_{clip} to the buffer 220 and terminates the processing.

By performing the processing as described beforehand, the clipping/non-contiguous allocation switching unit 21b can suitably switch between transmission by the non-contiguous allocation and transmission by the frequency clipping using the threshold which is different for each MCS.

Further, similar to the first modification, the clipping ratio R_{clip} can be calculated by the Expression (6) when the maximum cluster number is three or more regarding the second Embodiment. As a result, the wireless communication system can suitably switch between transmission by the non-contiguous allocation and transmission by the frequency clipping even when the maximum cluster number is three or more.

<Third Modification>

As previously described, a case in which the threshold Rₗᵢₘᵢₜ for determining whether or not to perform the frequency clipping is set by the MCS value was described, but a similar effect can be obtained by using information similar to MCS to have an influence on transmission quality. Further, using information known by both the transmitting device and the receiving device enables an increase in control information to be prevented by setting the threshold Rₗᵢₘᵢₜ, and to switch between transmission by the non-contiguous allocation and transmission by the frequency clipping without a decrease in transmission efficiency.

As the third modification, a case in which the threshold is changed depending on a rank, which is information representing a stream number performing transmission simultaneously regarding MIMO transmission will be described. When the rank value is smaller than the number of transmission antennae regarding MIMO transmission, the number of streams that can be transmitted simultaneously is restricted to the rank value. However, precoding processing can be applied in the transmitting device, which improves the error ratio due to a transmission diversity effect. Thus, a signal can be restored even for cases in which as the rank value corresponding to the number of transmission antennae decreases, the clipping ratio increases.

According to the wireless communication system related to the third modification, as the rank value corresponding to the number of transmission antennae decreases, the clipping ratio threshold value regarding the frequency clipping is set higher.

FIG. 20 is a schematic diagram illustrating an example threshold table related to the third modification. The threshold table is a threshold table corresponding a rank L and the threshold Rₗᵢₘᵢₜ. This threshold table illustrates an example case in which the number of antennae provisioned in a transmitting device 1c related to the third modification is four (maximum rank value is four). In this threshold table, the threshold Rₗᵢₘᵢₜ is 0.4 when L is one, the Rₗᵢₘᵢₜ is 0.35 when L is two, the Rₗᵢₘᵢₜ is 0.28 when L is three, and the Rₗᵢₘᵢₜ is 0.2 when L is four.

FIG. 20 illustrates that as the rank L value decreases, the threshold Rₗᵢₘᵢₜ value decreases, and illustrates that as the rank L value increases, the threshold Rₗᵢₘᵢₜ value increases.

However, the transmitting device 1c and a receiving device 2c can set the threshold value set for each rank depending on the required transmission quality. For example, this kind of table is provisioned in both the transmitting device 1c and the receiving device 2c, and the threshold can be set to the same value when applying the frequency clipping by notification the rank information from the receiving device 2c to the transmitting device 1c as control information.

[Configuration of Transmitting Device]

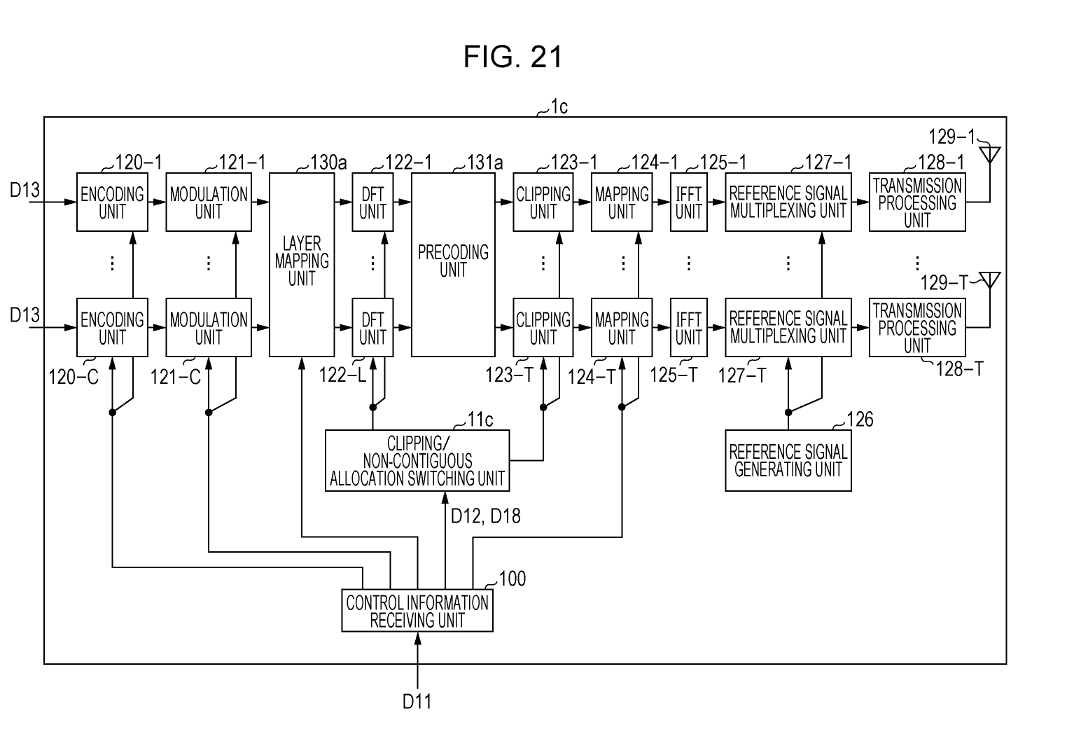

FIG. 21 is a schematic block diagram illustrating an example configuration of the transmitting device 1c related to the third modification. The transmitting device 1c is different in that the clipping/non-contiguous allocation switching unit 11 in the transmitting device 1a in FIG. 12 is replaced with a clipping/non-contiguous allocation switching unit 11c. Specifically, a rank information D18 is input into the clipping/non-contiguous allocation switching unit 11c in addition to the allocation information D12 by the control information receiving unit 100. The other configurations of the transmitting device 1c in FIG. 21 perform the same processing as the transmitting device 1b in FIG. 12 and have the same reference numerals, and the description of this processing is omitted.

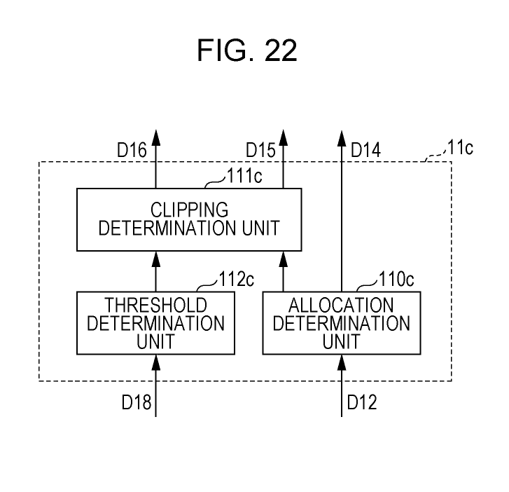

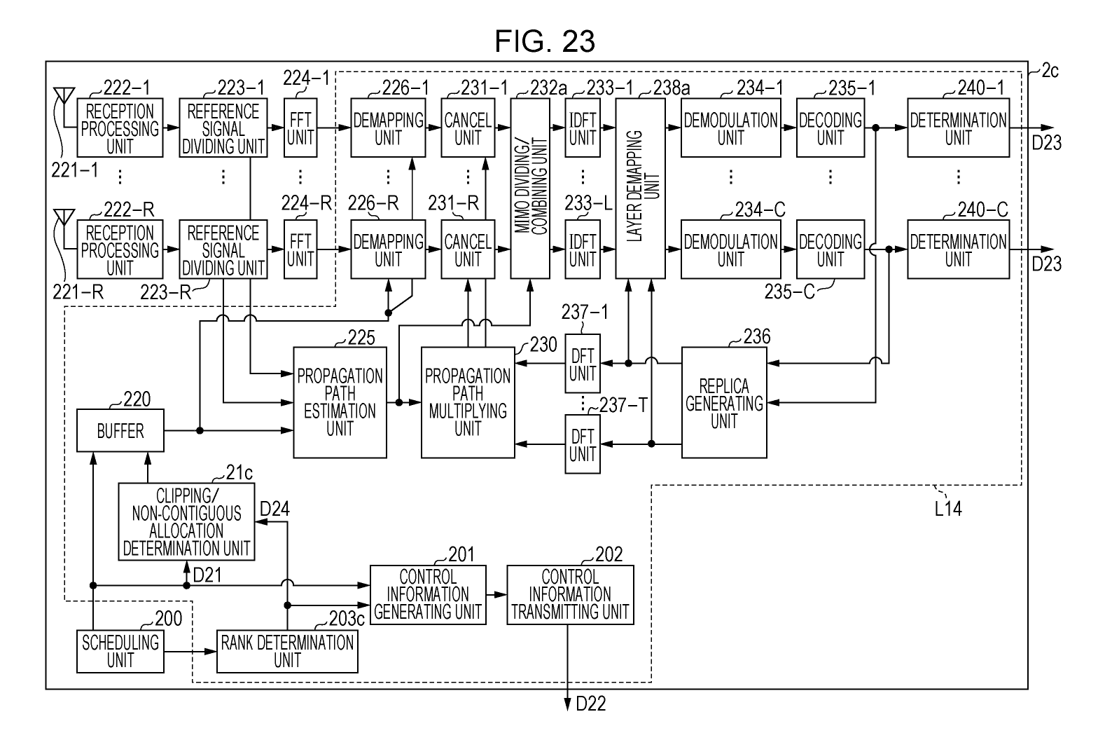

FIG. 22 is a schematic block diagram illustrating an example configuration of the clipping/non-contiguous allocation switching unit 11c related to the third modification. The clipping/non-contiguous allocation switching unit 11c is provisioned with a threshold determination unit 112c, an allocation determination unit 110c, and a clipping determination unit 111c.

The threshold determination unit 112c stores a threshold table corresponding the rank (L) such as illustrated in FIG. 20 and the threshold value (Rₗᵢₘᵢₜ). The threshold determination unit 112c determines the threshold Rₗᵢₘᵢₜ (L) on the basis of the rank information D18 input by the control information receiving unit 100 in FIG. 21 and the stored threshold table, and outputs the determined threshold Rₗᵢₘᵢₜ (L) to the clipping determination unit 111c.

The allocation determination unit 110c performs a processing similar to that of the allocation determination unit 110 in FIG. 6, and so its description is omitted.

Similar to the clipping determination unit 111 in FIG. 6, the clipping determination unit 111c performs a determination on whether or not to perform the frequency clipping by performing the processing in the flowchart illustrated in FIG. 7. However, the clipping determination unit 111c uses the Rₗᵢₘᵢₜ (L) input by the threshold determination unit 112c in addition to the threshold Rₗᵢₘᵢₜ at the step S103 in FIG. 7.

Specifically, the clipping determination unit 111c performs the following operation. After obtaining the allocation resource number N_{alloc} and the inter-cluster resource number Nᵢₙₜ from the allocation determination unit 110c, the clipping determination unit 111c calculates the clipping ratio R_{clip} when performing the frequency clipping by the Expression (1).

The clipping determination unit 111c determines not to perform the frequency clipping when R_{clip} is greater than Rₗᵢₘᵢₜ (L) (clipping ratio is over the threshold) and R_{clip} equals zero (allocation is the contiguous allocation). In this case, the clipping determination unit 111c substitutes the value of N_{alloc} into the DFT size N_{DFT}, and substitutes a zero in the clipping number N_{clip}.

The clipping determination unit 111c determines to perform the frequency clipping for all other cases substitutes the value of N_{alloc} plus Nᵢₙₜ into the DFT size N_{DFT}, and substitutes the value of Nᵢₙₜ into the clipping number N_{clip}.

The clipping determination unit 111c outputs the DFT size information representing the DFT size N_{DFT} to the DFT unit 122, outputs the clipping number N_{clip} to the clipping unit 123, and terminates the processing. However, the order of the output to the DFT unit 122 and the output to the clipping unit 123 can be reversed.

The clipping/non-contiguous allocation switching unit 11c can suitably switch between transmission by the non-contiguous allocation and transmission by the frequency clipping using the threshold different for each rank, by performing the processing described beforehand.

[Configuration of Receiving Device]

FIG. 23 is a schematic block diagram illustrating an example configuration of the receiving device 2c related to the third modification. The area enclosed by a dashed line L14 represents that the same processing is performed in parallel for each of the transmission devices 1c. Processing is performed in the configuration (block) within the dashed line L14 for each of the transmission devices 1c, and the data transmitted by each of the transmission devices 1c are restored as the received data.

The receiving device 2c is different in that a rank determination unit 203c is further provisioned to the receiving device 2a in FIG. 14, and the clipping/non-contiguous allocation determination unit 21a is replaced by a clipping/non-contiguous allocation determination unit 21c. The other configurations in the receiving device 2c in FIG. 23 perform the same processing as that of the receiving device 2a in FIG. 14 and have the same reference numerals, and so the description of this processing is omitted.

The rank determination unit 203c estimates the SINR (Signal to Interference and Noise Power Ratio) for the band used in transmission by the corresponding transmitting device 1c on the basis of the propagation path property and the allocation information D21 input by the scheduling unit 200. The rank determination unit 203c determines the optimal modulation method and encoding ratio for transmission, that is to say, the rank L, on the basis of the estimated SINR. The MCS determination unit 203b outputs a rank information D24 representing the determined rank L to the clipping/non-contiguous allocation determination unit 21c and the control information generating unit 201.

The clipping/non-contiguous allocation determination unit 21c generates the DFT size information representing the DFT size on the basis of the allocation information D21 input by the scheduling unit 200, and outputs the generated DFT size information to the IDFT units 233-1 through 233-L. The clipping/non-contiguous allocation determination unit 21c determines whether or not the frequency clipping was performed on the received signal from each of the transmission devices 1c using the rank L indicated by the rank information D24 input by the rank determination unit and the allocation information D21 input by the scheduling unit 200. The clipping/non-contiguous allocation determination unit 21c outputs the determination value k_{clip} as the determination result to the buffer 220.

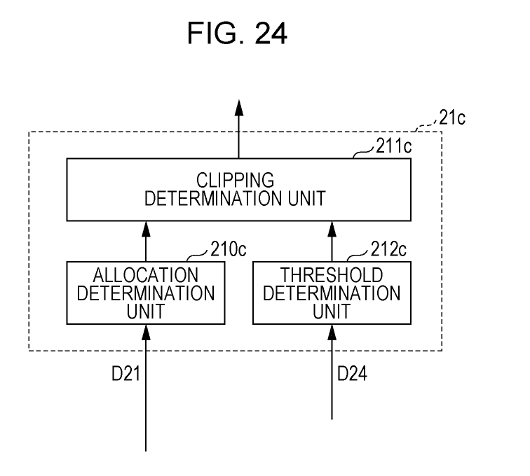

FIG. 24 is a schematic block diagram illustrating an example configuration of the clipping/non-contiguous allocation determination unit 21c related to the third modification. The clipping/non-contiguous allocation determination unit 21c is provisioned with an allocation determination unit 210c, a clipping determination unit 211c, and a threshold determination unit 212c.

The allocation determination unit 210c includes the same functionality as the allocation determination unit 210 in FIG. 9. The allocation determination unit 210c outputs the information representing the calculated N_{alloc} and Nᵢₙₜ to the clipping determination unit 211c.

The threshold determination unit 212c stores the same threshold table as that of the threshold determination unit 112c in the transmission device in FIG. 22 (FIG. 20). The threshold determination unit 212c determines the threshold Rₗᵢₘᵢₜ (L) on the basis of the rank L represented by the rank information input by the MCS determination unit 203b and the stored threshold table, and outputs the determined threshold Rₗᵢₘᵢₜ (L) to the clipping determination unit 211c.

The clipping determination unit 211c determines whether or not the frequency clipping was performed on the received signal from each of the transmission devices 1c by performing the processing in the flowchart illustrated in FIG. 10 similar to that by the clipping determination unit 211 in FIG. 9. However, the clipping determination unit 211c uses the Rₗᵢₘᵢₜ (L) input by the threshold determination unit 212c in addition to the threshold Rₗᵢₘᵢₜ at the step S103 in FIG. 10.

Specifically, the clipping determination unit 211c performs the following processing. After obtaining the allocation resource number N_{alloc} and the inter-cluster resource number Nᵢₙₜ from the allocation determination unit 210c, the clipping determination unit 211c calculates the clipping ratio R_{clip} when the frequency clipping was performed by the Expression (1).

The clipping determination unit 211c determines that the frequency clipping was not performed when the R_{clip} is greater than the Rₗᵢₘᵢₜ (L) (clipping ratio is over the threshold) and when R_{clip} equals zero (allocation is the contiguous allocation). In this case, the clipping determination unit 211c substitutes a zero into the determination value k_{clip}.

The clipping determination unit 211c determines that the frequency clipping was performed for all other cases, and substitutes a one in the determination value k_{chip}.

The clipping determination unit 211c outputs the determination value k_{clip} to the buffer 220 and terminates the processing.

By performing the processing as described beforehand, the clipping/non-contiguous allocation switching unit 21c can suitably switch between transmission by the non-contiguous allocation and transmission by the frequency clipping using the threshold which is different for each rank.

Thus, according to the second Embodiment, a wireless communication system in which the non-contiguous allocation and clipping technologies are both present can be achieved, and by using known information at both the transmitting device and receiving device, clipping and the non-contiguous allocation can be suitably switched, and throughput can be improved.

However, the second Embodiment was described using a case in which the threshold is set by the MCS as an example, and a case in which the threshold is set by a rank regarding MIMO transmission as the third modification, but a similar effect can be obtained by combining these threshold determining methods. That is to say, the threshold for determining whether or not to perform the frequency clipping can be determined from the two types of information, the MCS and the rank.

### Third Embodiment

Hereafter, the third Embodiment according to the present invention will be described in detail with reference to the drawings.

According to the first and second Embodiments, the examples described a case in which the maximum cluster number is two, and the clipping processing is performed only when the clipping ratio for performing the frequency clipping on the inter-cluster portion between two clusters is at or below the set threshold. Also, other examples described a case in which a similar processing is performed when the maximum cluster size is three or more.

The third Embodiment will be described for a case in which the wireless communication system performs the frequency clipping of a portion of the spectrum and performing the non-contiguous allocation without performing the frequency clipping for other portions of the spectrum, and the maximum cluster number is three or more. According the following example, the wireless communication system can switch between clipping and the non-contiguous allocation with the expectation to apply the frequency clipping on only the inter-cluster portions that have the narrowest bandwidth regarding that the maximum cluster number is three or more.

As a result, according to the wireless communication system, increases of cases in which the frequency clipping is not applied due to the clipping ratio when the frequency clipping is performed on all inter-cluster portions when the number of cluster divisions is great, rising over the threshold, due to being dispersive allocated over a wide range of a normal system band, can be prevented. According to the wireless communication system related to the third Embodiment, cases of determining to perform the frequency clipping increase, and transmission efficiency can be improved as compared to cases in which the determination on whether or not to perform the frequency clipping is conducted for the entire spectrum.

When the maximum cluster number is designated as N_{CL}, the allocation starting position Iₛₜₐᵣₜ (n) and the I_{end} (n) for each cluster (where 1≦n≦N_{CL}) is recognized at both a transmitting device 1d and a receiving device 2d using the allocation information. At this time, the bandwidth N (n) for an n number of clusters is expressed as N(n)=I_{end} (n)−Iₛₜₐᵣₜ (n)+1 (where 1≦n≦N_{CL}), and the total cluster resource number N_{alloc} is expressed by the following Expression (11).

$${N}_{alloc} = {\sum }_{n = 1}^{{N}_{CL}} N ( n ) \qquad ( 11 )$$

Also, the n number of clusters and the n+1 number for the inter-cluster bandwidth Nᵢₙₜ (n) is expressed as Nᵢₙₜ (n)=I_{end} (n+1)−Iₛₜₐᵣₜ (n)−1 (where 1≦n≦N_{CL}−1). Here, if the smallest values from an N_{CL}−1 number of Nᵢₙₜ (n) is expressed as min(Nᵢₙₜ(n)), the DFT size when performing the frequency clipping on only the inter-cluster portions having the narrowest bandwidth is expressed as N_{alloc}+min(Nᵢₙₜ(n)). Also, the clipping ratio R_{clip} is expressed by the following Expression (12) as the allocation resource number after the frequency clipping is N_{alloc}.

$${R}_{clip} = \frac{min ( {N}_{int} ( n ) )}{{N}_{alloc} + min ( {N}_{int} ( n ) )} \qquad ( 12 )$$

The transmitting device 1d and the receiving device 2d compare the calculated R_{clip} with a previously stored threshold Rₗᵢₘᵢₜ, and determines to perform non-contiguous allocation processing when the comparison result is “Rₗᵢₘᵢₜ<R_{clip}”. The transmitting device 1d and the receiving device 2d determines to perform the frequency clipping processing on a portion of the spectrum and non-contiguous allocation processing on the other portions of the spectrum when the comparison result is “Rₗᵢₘᵢₜ≧R_{clip}”.

However, according to the wireless communication system related to the third Embodiment, the frequency clipping is applied only for the inter-cluster portions in the narrowest band, and non-contiguous allocation is performed on other inter-cluster portions without generation or allocation of the spectrum. Also, according to the wireless communication system, when there are multiple inter-cluster portions having the smallest bandwidth, the frequency clipping can be used on the lower frequency band of the multiple inter-cluster portions, or the frequency clipping can be used on the higher frequency band, if this is previously defined. However, the definition on which inter-cluster portion to use in the frequency clipping is set on both the transmitting device 1d and the receiving device 2d.

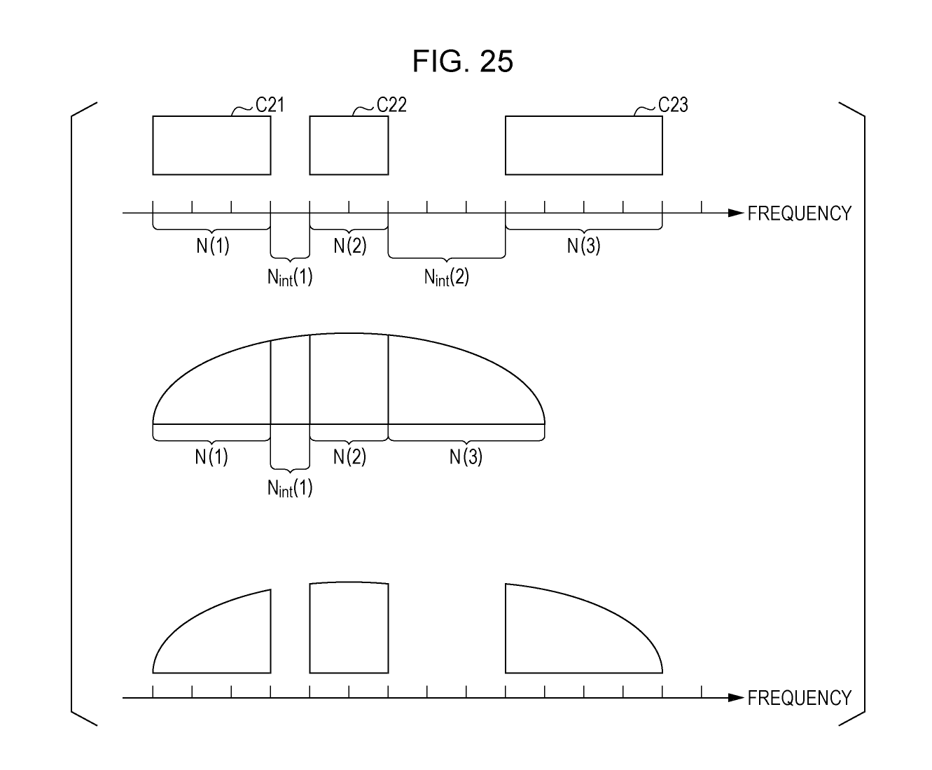

FIG. 25 is a schematic diagram illustrating an example allocation of the spectrum related to the third Embodiment of the present invention. FIG. 25 illustrates an example of switching between the frequency clipping and the non-contiguous allocation.

As illustrated in the upper area of FIG. 25, a first through third cluster C21 through C23 having a bandwidth of N(1)=3RBG, N(2)=2RBG, and N(3)=4RBG, respectively, are present. Also, as illustrated in the upper area of FIG. 25, the inter-cluster bandwidth between the first and second clusters is Nᵢₙₜ(1)=1RBG, and the inter-cluster bandwidth between the second and third clusters is Nᵢₙₜ(2)=3RBG.

The diagram in the middle of FIG. 25 illustrates a generated spectrum, and the diagram at the bottom of FIG. 25 illustrates an allocated spectrum.

As the portion with the smallest inter-cluster bandwidth is designated as Nᵢₙₜ (1), the clipping ratio Rₗᵢₘᵢₜ is calculated as 1 RBG regarding the bandwidth to be clipped. Here, the bandwidth of the frequency domain signal generated by DFT is 10 RGB derived from adding the clipping bandwidth of 1 RBG to the total allocation bandwidth, which is N(1)+N(2)+N(3), or 3+2+4=9 (RBG), and so the Rₗᵢₘᵢₜ is 0.1 derived by Expression (12) by dividing one by ten. Thus, when the previously determined threshold is at least 0.1, a clipping of 1 RBG is performed, and when the threshold is less than 0.1, the frequency clipping is not performed and only the non-contiguous allocation is performed.

[Configuration of Transmitting Device]

According to the transmitting device 1d related to the third Embodiment, the configurations other than a clipping/non-contiguous allocation switching unit 11d are the same as the configurations of the transmission device 1 in FIG. 5 related to the first Embodiment. Hereafter, the clipping/non-contiguous allocation switching unit 11d will be described omitting descriptions of the other configurations.

The clipping/non-contiguous allocation switching unit 11d generates the DFT size information representing the DFT size on the basis of the allocation information input by the control information receiving unit 100, and outputs the generated DFT size information to the DFT unit 122. The clipping/non-contiguous allocation switching unit 11 generates the clipping control information on the basis of the allocation information input by the control information receiving unit 100, and outputs the generated clipping control information to the clipping unit 123.

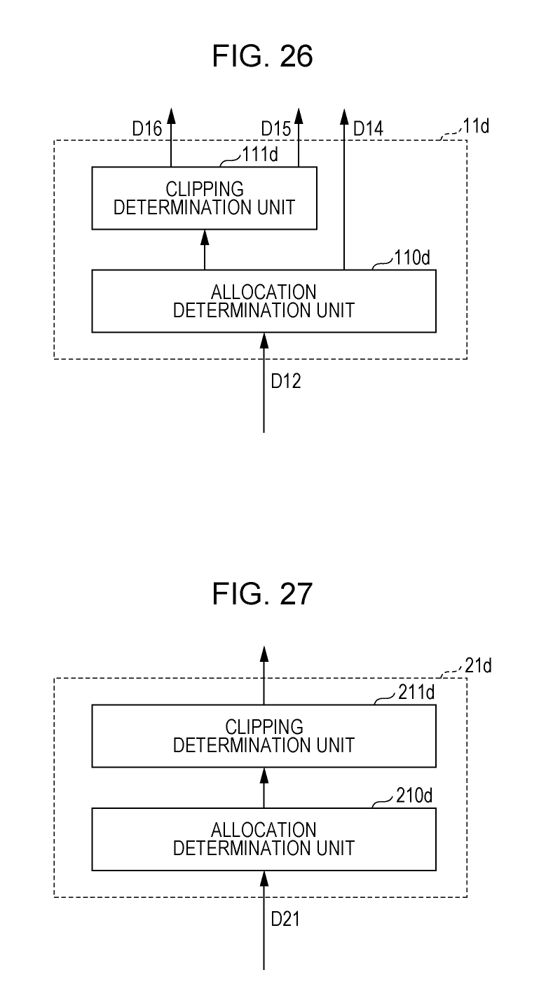

FIG. 26 is a schematic block diagram illustrating an example configuration of the clipping/non-contiguous allocation switching unit 11d related to the third Embodiment. The clipping/non-contiguous allocation switching unit 11d is provisioned with an allocation determination unit 110d and a clipping determination unit 111d.

The allocation determination unit 110d calculates the total resource number N_{alloc} for all clusters (Expression (11)) from the allocation information D12 input by the control information receiving unit 100 and the Nᵢₙₜ (nₘᵢₙ), which equals min (Nᵢₙₜ(n)) as the smallest value of the multiple inter-cluster resource numbers Nᵢₙₜ(n) when the allocation information is determined to be for the non-contiguous allocation. The allocation determination unit 110d calculates N_{alloc} as equal to I₁_{_{—}}_{end}−I₁_{_{—}}ₛₜₐᵣₜ+1 using the two units of allocation index information included in this allocation information, and sets Nᵢₙₜ to zero when the allocation information is determined to be for the contiguous allocation.

The allocation determination unit 110d outputs the information representing the calculated N_{alloc} and Nᵢₙₜ to the clipping determination unit 111.

Also, the allocation determination unit 110 calculates the index Nₛₜₐᵣₜ using the d and the following Expression (13). The allocation determination unit 110d outputs the information representing the calculated Nₛₜₐᵣₜ to the clipping unit 123.

$${N}_{start} = {\sum }_{n = 1}^{{n}_{min}} N ( n ) + 1 \qquad ( 13 )$$

Similar to the clipping determination unit 111 in FIG. 6, the clipping determination unit 111d performs a determination on whether or not to perform the frequency clipping by performing the processing in the flowchart illustrated in FIG. 7. However, the clipping determination unit 111d calculates the clipping ratio R_{clip} using the Expression (12) as the step S102 in FIG. 7. Also, the clipping determination unit 111d uses the clipping ratio R_{clip} calculated using the Expression (12) at the step S103 in FIG. 7.

[Configuration of Receiving Device]

According to the receiving device 2d related to the third Embodiment, the configurations other than a clipping/non-contiguous allocation determination unit 21d are the same as the configurations of the receiving device 2 in FIG. 8 related to the first Embodiment. Hereafter, the clipping/non-contiguous allocation determination unit 21d will be described omitting descriptions of the other configurations.

FIG. 27 is a schematic block diagram illustrating an example configuration of the clipping/non-contiguous allocation determination unit 21d related to the third Embodiment. The clipping/non-contiguous allocation determination unit 21d is provisioned with an allocation determination unit 210d and a clipping determination unit 211d.

The allocation determination unit 210d calculates the N_{alloc} and Nᵢₙₜ(nₘᵢₙ) using the allocation information D21 input by the scheduling unit 200 in FIG. 8 using the same expression as the allocation determination unit 110d in FIG. 26. The allocation determination unit 210d outputs the information representing the calculated N_{alloc} and Nᵢₙₜ(nₘᵢₙ) to the clipping determination unit 211d.

Similar to the clipping determination unit 211 in FIG. 9, the clipping determination unit 211d determines whether or not the frequency clipping was performed on all of or a portion of the received signal from each of the transmission devices 1d by performing the processing in the flowchart illustrated in FIG. 10. However, the clipping determination unit 211d calculates the clipping ratio R_{clip} using the Expression (12) at the step S202 in FIG. 10. Also, the clipping determination unit 211d uses the clipping ratio R_{clip} calculated using the Expression (12) at the step S203 in FIG. 10.

Specifically, the clipping determination unit 211d performs the following operation. After obtaining the allocation resource number N_{alloc} and the inter-cluster resource number Nᵢₙₜ(nₘᵢₙ) from the allocation determination unit 210d, the clipping determination unit 211d calculates the clipping ratio R_{clip} when the frequency clipping was performed using the Expression (12).

The clipping determination unit 211d determines that the frequency clipping was not performed when the R_{clip} is greater than the Rₗᵢₘᵢₜ (clipping ratio is over the threshold) and when the R_{clip} equals zero (allocation is the contiguous allocation). In this case, the clipping determination unit 211d substitutes a zero into the determination value k_{clip}.

The clipping determination unit 211d determines that the frequency clipping was performed for all other cases (when R_{clip} is not greater than Rₗᵢₘᵢₜ), and substitutes a one into the determination value k_{clip}.

The clipping determination unit 211d outputs the determination value k_{clip} to the buffer 220 and the processing terminates.

In this way, according to the third Embodiment, a wireless communication system in which both the non-contiguous allocation and the frequency clipping are present can be achieved. According to the wireless communication system, there is no setting of an excessive clipping ratio regarding the clipping processing using the allocation information for multiple clusters, and the non-contiguous allocation and the frequency clipping can be suitably switched.

Further, the third Embodiment described beforehand was described for a case in which the spectrum allocation and clipping processing is performed only on inter-cluster resources having the narrowest band from the multiple inter-cluster portions represented by the allocation information, but the third Embodiment of the present invention is not limited thusly. For example, as a modification of the third Embodiment, the wireless communication system can apply clipping to two or more inter-cluster resources having the narrowest bandwidths from the multiple inter-cluster portions.

Further, regarding the first through third Embodiments described beforehand, the index was designated as a value representing the allocation unit number in order from the low frequencies within the band that can allocate the wireless resources. However, the first through third Embodiments of the present invention is not limited thusly, and so the index can be a value representing the allocation unit (resource) number in order from the high frequencies, or may not be in any particular order.

Also, regarding the first through third Embodiments described beforehand, the decoding unit 235 can determine the number of repetitions of the repeating processing (previously determined M number of repetitions) as different values for each of the transmission devices 1, and can determine determines different values depending on whether or not the frequency clipping was performed (value of the determination value k_{clip}).

For example, the decoding unit 235 can determine that the M number of repetitions is a larger value or may determine this to be a smaller value when the determination value k_{clip} is zero than when the determination value k_{clip} is one. For the former case, for example, the receiving device 2 performs the repeating processing for more repetitions when the frequency clipping is performed as compared to when it is not performed. Also, the decoding unit 235 can determine the M number of repetitions depending on the clipping number N_{clip}. For example, the decoding unit 235 can determines the M number of repetitions as a larger value when the value of the clipping number N_{clip} is large as compared to when the value of the clipping number N_{clip} is small.

Also, regarding the first through third Embodiments described beforehand, a portion of or all of the configuration of the transmitting device and the receiving device can be provisioned in a relay station device.

Also, regarding the first through third Embodiments described beforehand, the wireless communication system was described for a case in which two units of the index information (I₁_{_{—}}ₛₜₐᵣₜ and I₁_{_{—}}_{end}) are used for the contiguous allocation, but the first through third Embodiments of the present invention are not limited thusly. For example, according to the wireless communication system, a 2n units of the index information is used when there an n number of clusters, and a previously determined value (zero, for example) is designated for indexes other than the two units of indexes (I₁_{_{—}}ₛₜₐᵣₜ and I₁_{_{—}}_{end}, for example) in a case of contiguous allocation. In this case, each device in the wireless communication system determines contiguous allocations when the indexes other than the two indexes (I₁_{_{—}}ₛₜₐᵣₜ and I₁_{_{—}}_{end}, for example) are all set to the previously determined value (zero, for example), and determines non-contiguous allocations for all other cases. Also, each device notifies information representing whether the allocation is the contiguous allocation or the non-contiguous allocation, and can determines whether the allocation is the contiguous allocation or the non-contiguous allocation on the basis of this information.

Also, regarding the first through third Embodiments described beforehand, the clipping unit 123 can designate the clipping position as a predetermined position for the spectrum independent of the N₁ if this is previously defined. For example, the spectrum corresponding to the Nᵢₙₜ number of resources can be removed from the high frequency components of the input frequency domain signal, and this can be output as the frequency domain signal of the size N_{alloc}.

Further, regarding the first through third Embodiments described beforehand, the transmission device 1 multiplexes the post-IFFT time domain signal and the reference signal, but the first through third Embodiments of the present invention is not limited thusly, and so can be multiplexed at the frequency domain, for example, multiplexing the pre-IFFT frequency domain signal and the reference signal.

Further, the first through third Embodiments described beforehand were described for a case in which the allocation information is stored in the buffer 220 after the clipping determination, but the first through third Embodiments of the present invention are not limited thusly, and so the receiving device 2 can store the allocation information output by the scheduling unit 200 in the buffer 220, and perform the determination by the clipping determination unit 211 from the allocation information output from the buffer 220. Also, the function of the clipping/non-contiguous allocation determination unit 21 can be included in the demapping unit 226 and the propagation path estimating unit 225, and only the allocation information can be stored in the buffer 220.

Also, regarding the third Embodiment described beforehand, when the calculated R_{clip} is compared with the previously stored threshold Rₗᵢₘᵢₜ, and the comparison result is that the Rₗᵢₘᵢₜ is greater than or equal to the R_{clip}, the transmitting device 1d and the receiving device 2d can perform the non-contiguous allocation processing on a portion of the spectrum (for example, the portion of the spectrum before and after the cluster in which the inter-cluster bandwidth is either the smallest or the largest), and can perform the frequency clipping processing for the other portions of the spectrum.

For example, when the calculated R_{clip} is compared with the previously stored threshold Rₗᵢₘᵢₜ, and the comparison result is that the Rₗᵢₘᵢₜ is less than the R_{clip}, the transmitting device 1d and the receiving device 2d determine to perform the frequency clipping processing on a portion of the spectrum, and determine to perform the non-contiguous allocation processing on the other portions of the spectrum. When the comparison result is that the Rₗᵢₘᵢₜ is greater than or equal to the R_{clip}, the transmitting device 1d and the receiving device 2d determine to perform the frequency clipping.

Further, a portion of the transmission device 1, 1a, 1b, 1c, and 1d, and the receiving device 2, 2a, 2b, 2c, and 2d according to the first through third Embodiments described beforehand can be implemented on a computer. In this case, a program for implementing these control functions is recorded on a computer-readable recording medium, the program recorded on this recoding medium can be read and executed by the computer system to implement these functions. Further, the “computer system” stated here is a computer system installed in the transmission device 1, 1a, 1b, 1c, and 1d, and the receiving device 2, 2a, 2b, 2c, and 2d, and includes an OS, peripheral devices, and other hardware.

Also, the “computer-readable recording medium” refers to removable media such as flexible disk, magneto-optical disk, ROM, and CD-ROM, or recording devices such as a hard disk installed in the computer system. Further, the “computer-readable recording medium” can also include communication lines such as when transmitting the program over communication lines such as telephone lines or a network such as the Internet, volatile memory in a computer system functioning as a server or client in such a case as when storing the program temporarily and dynamically, and media storing the program for a definite amount of time. Also, the program can be used to implement a portion of the functions described beforehand, can be used in combination with another program already installed in the computer system in order to implement the functions described beforehand.

Also, a portion of or all of the transmission device 1, 1a, 1b, 1c, and 1d, and the receiving device 2, 2a, 2b, 2c, and 2d according to the first through third Embodiments described beforehand can be implemented as an integrated circuit such as an LSI (Large Scale Integration). Each functional block of the transmission device 1, 1a, 1b, 1c, and 1d, and the receiving device 2, 2a, 2b, 2c, and 2d can be processed individually, or a portion of or all of these can be processed together. Also, the integrated circuit technique is not limited to LSI, and so can include specialized circuits or general-purpose processors to implement the functional blocks. Also, in the event that an integrated circuit technology emerges to replace LSI due to advances in semiconductor technology, integrated circuits by this technology can be used.

Thus, the embodiments of the present invention have been described in detail with reference to the drawings, but the specific configurations are not limited to that described beforehand, and various design modifications and so on are possible as long as they do not deviate from the scope of the present invention.

### INDUSTRIAL APPLICABILITY

The present invention can be applied to a wireless communication system, a wireless communication method, a transmitting device, and a processor that can perform the frequency clipping while preventing a decrease in transmission efficiency.

### REFERENCE SIGNS LIST

1, 1-1, 1-2, 1a, 1a-1, 1a-2, 1b, 1c, 1d transmitting device
2, 2a, 2b, 2c, 2d receiving device
100 control information receiving unit
11, 11b, 11c, 11d clipping/non-contiguous allocation switching unit
120, 120-1 through 120-C encoding unit
121, 121-1 through 121-C modulation unit
122, 122-1 through 122-L DFT unit
123, 123-1 through 123-T clipping unit
124, 124-1 through 124-T mapping unit
125, 125-1 through 125-T IFFT unit
126 reference signal generating unit
127, 127-1 through 127-T reference signal multiplexing unit
128, 128-1 through 128-T transmission processing unit
129, 129-1 through 129-T transmission antenna
130a layer mapping unit
131a precoding unit
110, 110b, 110c, 110d allocation determination unit
111, 111b, 111c, 111d clipping determination unit
112b, 112c threshold determination unit
200 scheduling unit
201 control information generating unit
202 control information transmission unit
203b MCS determination unit
203c rank determination unit
21, 21b, 21c, 21d clipping/non-contiguous allocation determination unit
220 buffer
221, 221-1 through 221-R reception antenna
222, 222-1 through 222-R reception processing unit
223, 223-1 through 223-R reference signal dividing unit
224, 224-1 through 224-R FFT unit
225 propagation path estimating unit
226, 226-1 through 226-R demapping unit
230 propagation path multiplying unit
231, 231-1 through 231-R cancel unit
232 equalizing unit
232a MIMO dividing/combining unit
233, 233-1 through 233-L IDFT unit
234, 234-1 through 234-C demodulation unit
235, 235-1 through 235-C decoding unit
236 replica generating unit
237, 237-1 through 237-L DFT unit
238a layer demapping unit
240, 240-1 through 240-C determination unit
210, 210b, 210c, 210d allocation determination unit
211, 211b, 211c, 211d clipping determination unit
212b, 212c threshold determination unit

1. A wireless communication system comprising:
a first communications device configured to transmit a signal; and
a second communications device configured to receive the signal,
wherein the second communications device is provisioned with a transmitting unit to transmit a control information, which represents a frequency band used by the first communications device to transmit data, to the first communications device, and wherein
the first communications device is provisioned with a determination unit to determine whether or not to perform a the frequency clipping to remove a portion of a spectrum of the signal to transmit on the basis of the control information.

2. The wireless communication system according to claim 1,
wherein the control information is information representing that the spectrum of the signal transmitted by the first communications device is allocated non-contiguously in the frequency.

3. The wireless communication system according to claim 1,
wherein the first communications device determines whether or not to perform the frequency clipping on the basis of whether or not the frequency band represented by the control information satisfies predetermined conditions.

4. The wireless communication system according to claim 3,
wherein the first communications device determines to perform the frequency clipping when a clipping ratio that can be calculated from the frequency band represented by the control information is smaller than a predetermined threshold, and determines not to perform the frequency clipping when the clipping ratio is larger than the predetermined threshold.

5. The wireless communication system according to claim 4,
wherein the clipping ratio is a ratio calculated when the frequency band represented by the control information is divided into a plurality of clusters and allocated into a non-contiguous allocation, and all of the band between the clusters is lost due to clipping.

6. The wireless communication system according to claim 4,
wherein the clipping ratio is a ratio calculated when the frequency band represented by the control information is divided into a plurality of clusters and allocated into a non-contiguous allocation and the narrowest band of the inter-cluster portion of the band between clusters is lost due to clipping.

7. The wireless communication system according to claim 4,
wherein the predetermined threshold is a constant value set between both the first communications device and the second communications device.

8. The wireless communication system according to claim 4,
wherein the predetermined threshold is a value set on the basis of information known between both the first communications device and the second communications device.

9. The wireless communication system according to claim 8,
wherein the known information is an MCS information used when the first communication device transmits.

10. The wireless communication system according to claim 8,
wherein the known information is an MIMO rank information used when the first communication device transmits.

11. A wireless communication method for a wireless communication system provisioned with a first communications device to transmit a signal, and a second communications device to receive the signal,
wherein the second communications device transmits a control information, which represents a frequency band used by the first communications device to transmit data, to the first communications device,
and wherein the first communications device determines whether or not to perform a the frequency clipping to remove a portion of a spectrum of the signal to transmit on the basis of the control information.

12. A transmitting device configured to transmit a signal, the transmitting device comprising:
a determination unit configured to determine whether or not to perform a the frequency clipping to remove a portion of a spectrum of the signal to transmit on the basis of a control information representing a frequency band used by the transmitting device to transmit data.

13. (canceled)
